(19) United States
(12) Patent Application Publication
(10) Pub. No.: US 2026/0313509 A1
(43) Pub. Date: Oct. 8, 2026

(54) METHOD AND DEVICE FOR LINKING TWO TECHNIQUES FOR MANAGING KEYS IN DUAL CONNECTIVITY IN MOBILE COMMUNICATION SYSTEM

(71) Applicant: Samsung Electronics Co., Ltd., Suwon-si, Gyeonggi-do (KR)

(72) Inventors: Taehyung LIM, Suwon-si (KR); Hongjin CHOI, Suwon-si (KR)

(21) Appl. No.: 19/481,424

(22) PCT Filed: May 3, 2024
(86) PCT No.: PCT/KR2024/006040

§ 371 Date: Nov. 4, 2025

(30) Foreign Application Priority Data
May 8, 2023 (KR) 10-2023-0059137
Dec. 20, 2023 (KR) 10-2023-0187472

(51) Int. Cl. H04W 36/36; H04W 12/041; H04W 12/0431

(52) U.S. Cl. CPC H04W 36/362; H04W 12/041; H04W 12/0431

(57) ABSTRACT

The present disclosure relates to a 5G or 6G communication system to support a higher data transmission rate. An operation of a master node (MN) connected to a user terminal in a wireless communication system according to the present disclosure may comprise the steps of: selecting a first secondary node (SN) counter value for a first target SN that does not support an optional secondary cell group (5CG) function; on the basis of the first SN counter value, generating a first key value for secure communication between the user terminal and the first target SN; transmitting, to the first target SN, the first key value corresponding to the first target SN; selecting multiple second SN counter values for a second target SN supporting the optional SCG function; on the basis of the multiple second SN counter values, generating multiple second key values for secure communication between the user terminal and the second target SN; transmitting, to the second target SN, the multiple second key values corresponding to the second target SN; and transmitting, to the user terminal, conditional PSCell change (CPC) configuration information, the first SN counter value, and the multiple second SN counter values.

### TECHNICAL FIELD

The disclosure relates to a method and a device for, when two techniques are used by a UE to manage keys during dual connectivity in a wireless communication system, linking the two techniques.

### BACKGROUND ART

5G mobile communication technologies define broad frequency bands to enable high transmission rates and new services, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (e.g., 95 GHz to 3 THz bands) in order to accomplish transmission rates fifty times faster than 5G mobile communication technologies and ultra-low latencies one-tenth of 5G mobile communication technologies.

In the initial stage of 5G mobile communication technologies, in order to support services and to satisfy performance requirements in connection with enhanced Mobile BroadBand (eMBB), Ultra Reliable & Low Latency Communications (URLLC), and massive Machine-Type Communications (mMTC), there has been ongoing standardization regarding beamforming and massive MIMO for alleviating radio-wave path loss and increasing radio-wave transmission distances in mm Wave, numerology (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large-capacity data transmission and a polar code for highly reliable transmission of control information, L2 pre-processing, and network slicing for providing a dedicated network customized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR UE Power Saving, Non-Terrestrial Network (NTN) which is UE-satellite direct communication for securing coverage in an area in which communication with terrestrial networks is unavailable, and positioning.

Moreover, there has been ongoing standardization in wireless interface architecture/protocol fields regarding technologies such as Industrial Internet of Things (IloT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service fields regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR), etc., 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for securing coverage in terahertz bands of 6G mobile communication technologies, Full Dimensional MIMO (FD-MIMO), multi-antenna transmission technologies such as array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

A user equipment (UE) may perform dual connectivity. In dual connectivity, a base station (BS) providing macro cell coverage may become a master BS (master node (MN)) to process both a control plane and a user plane, and another BS having small cell coverage may be called a secondary BS (secondary node (SN)) and serve as an assistant to handle only the user plane. That is, the MN may process control signaling, and the SN may be used to improve a data transmission rate. The MN may provide conditional PSCell change (CPC) configuration information to the UE, and the UE may evaluate the condition and, when the condition is satisfied, make a request for a change to the corresponding SN. Further, the UE may store the CPC configuration information for several SNs provided by the MN and continuously make a request for changing the SN whenever the condition is satisfied after the evaluation.

### DISCLOSURE

### Technical Problem

Based on the above-described discussion, the disclosure seeks to solve the following problem. The number of schemes of managing a key to be used for security in dual connectivity may be plural. For example, when a new scheme is introduced, a BS which has been updated to use the new scheme and a BS which has not been updated and thus cannot use yet the new scheme may coexist. In this case, a new method is needed to link and use two different types of BSs. The disclosure proposes a technology of making the method possible and intends to solve the problem.

### Technical Solution

A method of operating a master node (MN) connected to a user equipment (UE) in a wireless communication system may include selecting a first secondary node (SN) counter value for a first target SN not supporting a selective secondary cell group (SCG) function, generating a first key value for secure communication between the UE and the first target SN, based on the first SN counter value, transmitting the first key value corresponding to the first target SN to the first target SN, selecting a plurality of second SN counter values for a second target SN supporting the selective SCG function, generating a plurality of second key values for secure communication between the UE and the second target SN, based on the plurality of second SN counter values, transmitting the plurality of second key values corresponding to the second target SN to the second target SN, and transmitting conditional PSCell change (CPC) configuration information, the first SN counter value, and the plurality of second SN counter values to the UE.

The method may further include receiving information on whether the first target SN supports the selective SCG function from the first target SN and receiving information on whether the second target SN supports the selective SCG function from the second target SN.

The CPC configuration information may include information on whether the first target SN or the second target SN supports the selective SCG function.

The method may further include receiving a rejection message for a key value received by the first target SN or the second target SN or a request message for an additional key value from the first target SN or the second target SN.

The method may further include transmitting information on whether the first target SN not supporting the selective SCG function can be reused to the UE.

The method may further include receiving a request for reuse of the first target SN from the UE in case that the first target SN can be reused, selecting a third SN counter value for the first target SN and generating a third key value, based on the selected third SN counter value, transmitting the third key value to the first target SN, and transmitting the third SN counter value corresponding to the third key value to the UE.

A method of operating a user equipment (UE) in a wireless communication system may include receiving, from a master node (MN) connected to the UE, conditional PSCell change (CPC) configuration information, a first SN counter value corresponding to a first key value transferred to a first target secondary node (SN) not supporting a selective secondary cell group (SCG) function, and a plurality of second SN counters corresponding to a plurality of second key values transmitted to a second target SN supporting the selective SCG function, generating a first key value or a second key value, based on at least one of the first SN counter value or the plurality of second SN counter values, and performing an SN change to the first target SN through the first key value or an SN change to the second target SN through the second key value.

The CPC configuration information may include information on whether the first target SN or the second target SN supports the selective SCG function, and a change to the second target SN made by the UE may be made several times by using the plurality of second key values generated based on the CPC configuration information.

According to another embodiment of the disclosure, a master node (MN) operatively connected to a user equipment (UE) in a wireless communication system may include a communication unit and a controller, wherein the controller may be configured to select a first secondary node (SN) counter value for a first target SN not supporting a selective secondary cell group (SCG) function, generate a first key value for secure communication between the UE and the first target SN, based on the first SN counter value, transmit the first key value corresponding to the first target SN to the first target SN, select a plurality of second SN counter values for a second target SN supporting the selective SCG function, generate a plurality of second key values for secure communication between the UE and the second target SN, based on the plurality of second SN counter values, transmit the plurality of second key values corresponding to the second target SN to the second target SN, and transmit conditional PSCell change (CPC) configuration information, the first SN counter value, and the plurality of second SN counter values to the UE.

### Advantageous Effects

Various embodiments of the disclosure can provide a device and a method capable of effectively providing services in a wireless communication system.

According to an embodiment of the disclosure, when a new scheme of managing a security key is introduced in the case where dual connectivity is used, a method of efficiently applying the new scheme to the case where a BS to which the corresponding scheme has been updated and a BS to which the scheme has not been updated coexist.

Advantageous effects obtainable from the disclosure may not be limited to the above-mentioned effects, and other effects which are not mentioned herein may be clearly understood from the following description by those skilled in the art to which the disclosure pertains.

### DESCRIPTION OF DRAWINGS

FIG. 1A illustrates a communication network including core network entities in a wireless communication system according to various embodiments of the disclosure.

FIG. 1B illustrates a radio environment including a core network in a wireless communication system according to various embodiments of the disclosure.

FIG. 2A illustrates an example of a functional structure of a UE according to embodiments of the disclosure.

FIG. 2B illustrates an example of a functional structure of a base station according to embodiments of the disclosure.

FIG. 2C illustrates an example of a functional structure of a core network entity according to embodiments of the disclosure.

FIG. 3 is a diagram illustrating a method of managing keys in dual connectivity according to an embodiment of the disclosure.

FIG. 4 is a diagram illustrating a procedure of changing a secondary node in dual connectivity, based on the method illustrated in FIG. 3.

FIG. 5 is a diagram illustrating another method of managing keys in dual connectivity according to an embodiment of the disclosure.

FIG. 6 is a diagram illustrating a procedure of changing a secondary node in dual connectivity, based on the method illustrated in FIG. 5.

FIG. 7 is a diagram illustrating a procedure of continuously changing a secondary node in dual connectivity by linking the two methods illustrated in FIGS. 3 and 5.

FIG. 8 is a diagram illustrating another procedure of continuously changing a secondary node in dual connectivity by linking the two methods illustrated in FIGS. 3 and 5.

FIG. 9 is a diagram illustrating another method of managing keys in dual connectivity according to an embodiment of the disclosure.

FIG. 10 is a diagram illustrating a procedure of changing a secondary node in dual connectivity, based on the method illustrated in FIG. 9.

FIG. 11 is a diagram illustrating a procedure of continuously changing a secondary node in dual connectivity by linking the two methods illustrated in FIGS. 3 and 9.

FIG. 12 is a diagram illustrating another procedure of continuously changing a secondary node in dual connectivity by linking the two methods illustrated in FIGS. 3 and 9.

FIG. 13 is a diagram illustrating another method of managing keys in dual connectivity according to an embodiment of the disclosure.

FIG. 14 is a diagram illustrating a procedure of changing a secondary node in dual connectivity, based on the method illustrated in FIG. 13.

FIG. 15 is a diagram illustrating another procedure of continuously changing a secondary node in dual connectivity by linking the two methods illustrated in FIGS. 3 and 13.

### MODE FOR INVENTION

The terms used in the disclosure are used merely to describe particular embodiments, and may not be intended to limit the scope of other embodiments. A singular expression may include a plural expression unless they are definitely different in a context. The terms used herein, including technical and scientific terms, may have the same meaning as those commonly understood by a person skilled in the art to which the disclosure pertains. Such terms as those defined in a generally used dictionary may be interpreted to have the meanings equal to the contextual meanings in the relevant field of art, and are not to be interpreted to have ideal or excessively formal meanings unless clearly defined in the disclosure. In some cases, even the term defined in the disclosure should not be interpreted to exclude embodiments of the disclosure.

Hereinafter, various embodiments of the disclosure will be described based on an approach of hardware. However, various embodiments of the disclosure include a technology that uses both hardware and software, and thus the various embodiments of the disclosure may not exclude the perspective of software.

In order to promote evolution from the conventional 4G LTE system to the 5G system, a 3GPP in charge of cellular mobile communication standards has named a new core network structure as a 5G core (5GC) and standardized it. The 5GC supports the following differentiated functions compared to an evolved packet core (EPC) that is a network core for the conventional 4G.

First, a network slice function is introduced in the 5GC. As requirements of 5G, the 5GC should support various types of UEs and services (for example, eMBB, URLLC, or mMTC service). Various types of services have different requirements required for the core network. For example, the eMBB service requires a high data rate, and the URLLC service requires high stability and low latency. One of the technologies proposed to satisfy the various service requirements is network slicing.

The network slicing is a method of virtualizing one physical network to generate several logical networks, and network slice instances (NSIs) may have different characteristics. Accordingly, every NSI may have a network function (NF) suitable for the characteristic and thus meet various service requirements. When the NSI suitable for the service characteristic required for each UE is allocated, various 5G services may be efficiently supported.

Second, the 5GC may easily support a network virtualization paradigm through separation of a mobility management function and a session management function. In the 4G long-term evolution (LTE), the service may be provided through a signaling exchange with single core equipment that is a mobility management entity (MME) in charge of registration, authentication, mobility management, and session management functions for all UEs. However, when the single equipment such as the MME supports all functions as the number of UEs explosively increases and mobility and traffic/session characteristics, which should be supported according to the UE type, are subdivided in the 5G, scalability for adding entities according to each of the required functions cannot help being reduced. Accordingly, various functions are developed based on a structure of separating a mobility management function and a session management function in order to improve a function/implementation complexity of a core equipment in charge of the control plane and expandability in the light of signaling load.

Hereinafter, various embodiments will be described in detail in conjunction with the accompanying drawings. In describing the disclosure below, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

For the same reason, in the accompanying drawings, some elements may be exaggerated, omitted, or schematically illustrated. Also, the size of each element does not completely reflect the actual size thereof. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the disclosure, the same or like reference numerals designate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in various embodiments of the disclosure, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card.

In the following description, a base station is an entity that allocates resources to terminals, and may be at least one of an eNode B (eNB), a Node B, a base station (BS), a radio access network (RAN), an access network (AN), a RAN node, a NR NB, a gNB, a wireless access unit, a base station controller, and a node on a network. A terminal may include a user equipment (UE), a mobile station (MS), a cellular phone, a smartphone, a computer, or a multimedia system capable of performing a communication function. In various embodiments of the disclosure, the case where the terminal is a UE will be described by way of example. Furthermore, in the following description of various embodiments, systems based on LTE, LTE-A, or NR may be described by way of example, but various embodiments of the disclosure may also be applied to other communication systems having similar technical backgrounds or channel types. Moreover, based on determinations by those skilled in the art, various embodiments of the disclosure may also be applied to other communication systems through some modifications without significantly departing from the scope of the embodiments of the disclosure.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

Furthermore, various embodiments of the disclosure will be described using terms used in some communication standards (e.g., the 3rd generation partnership project (3GPP)), but they are for illustrative purposes only. Various embodiments of the disclosure may also be easily applied to other communication systems through modifications. Hereinafter, some terms used in a core network of the disclosure will be defined before explanation.
AMF Access and Mobility Management Function
CN Core Network
CNF Containerized Network Function
DNN Data Network Name
PCF Policy Control Function
HSS Home Subscriber Server
SMF Session Management Function
UDM User Data Management
UPF User Plane Function
CNF Containerized Network Function
VNF Virtual Network Function
AMF Access and Mobility Management Function
CN Core Network
CNF Containerized Network Function
DNN Data Network Name
PCF Policy Control Function
HSS Home Subscriber Server
SMF Session Management Function
UDM User Data Management
UPF User Plane Function
CNF Containerized Network Function
VNF Virtual Network Function

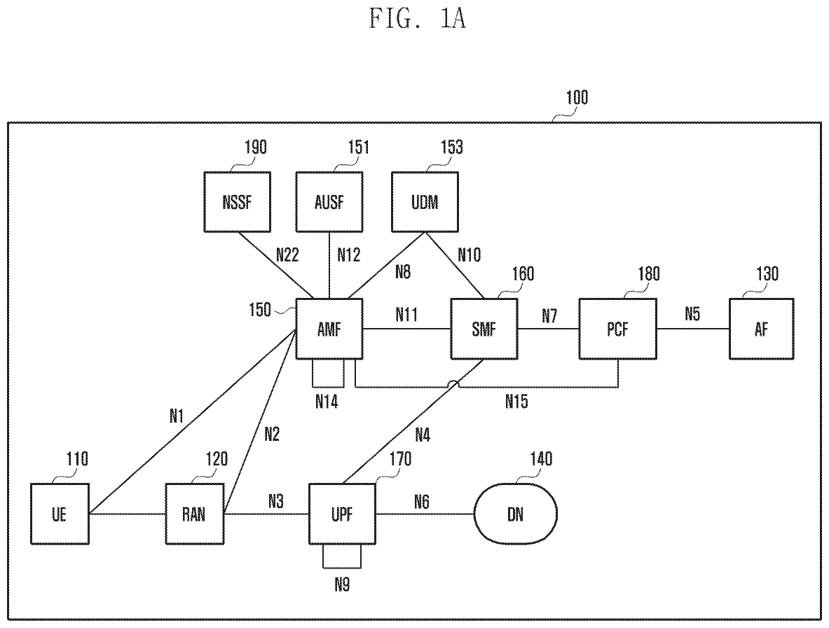

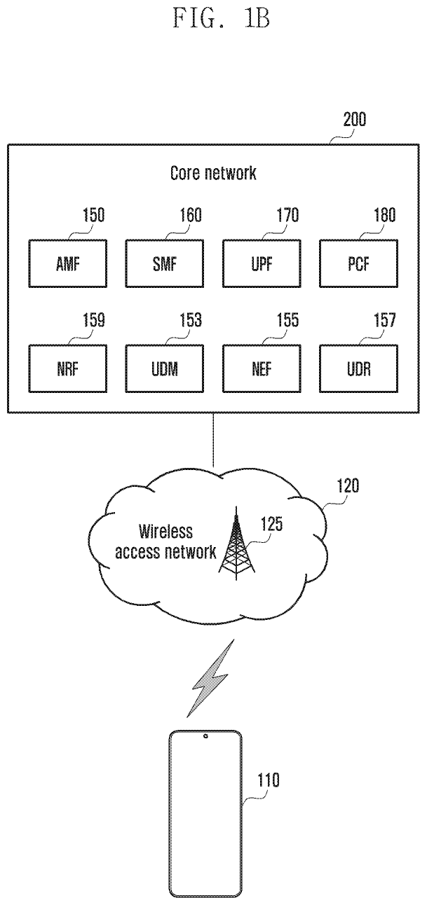

FIG. 1A illustrates a communication network including core network entities in a wireless communication system according to various embodiments of the disclosure. A 5G mobile communication network may include a 5G user equipment (5G UE) 110, a 5G radio access network (5G RAN) 120, and a 5G core network.

The 5G core network may include network functions, such as an access and mobility management function (AMF) 150 that provides a mobility management function of the UE, a session management function (SMF) 160 that provides a session management function, a user plane function (UPF) 170 that serves to transfer data, a policy control function (PCF) 180 that provides a policy control function, a unified data management (UDM) 153 that functions to manage data, such as subscriber data and policy control data, or a unified data repository (UDR) that stores data of various network functions.

Referring to FIG. 1A, the user equipment (UE) 110 may perform communication through a radio channel, that is, an access network, established between the UE and a base station (e.g., eNB or gNB). In some embodiments, the UE 110 refers to a device used by a user, and may be a device configured to provide a user interface (UI). For example, the UE 110 may be a UE equipped in a vehicle for driving. In some other embodiments, the UE 110 may be an autonomous vehicle or a device that performs machine type communication (MTC) operated without the user's involvement. In addition to the term “electronic device”, the UE may be referred to as a “terminal”, a “vehicle terminal”, a “user equipment (UE)”, a “mobile station”, a “subscriber station”, a “remote terminal”, a “wireless terminal”, “a user device”, or other terms having a technical meaning equivalent thereto. In addition to the UE, a customer-premises equipment (CPE) or a dongle type UE may be used as the terminal. The customer-premises equipment not only may be connected to an NG-RAN node like the UE, but may also provide a network to other communication equipment (e.g., laptop).

Referring to FIG. 1A, the AMF 150 may provide a function for access and mobility management in units of UEs 110, and basically one UE 110 may be connected to one AMF 150. Specifically, the AMF 150 may perform at least one function among signaling between core network nodes for mobility between 3GPP access networks, an interface (N2 interface) between radio access networks (e.g., 5G RAN) 120, NAS signaling with the UE 110, identification of the SMF 160, and delivery of a session management (SM) message between the UE 110 and the SMF 160. Some or all functions of the AMF 150 may be supported within a single instance of one AMF 150.

Referring to FIG. 1A, the SMF 160 may provide a session management function, and when the UE 100 has multiple sessions, each session may be managed by different SMFs 160. Specifically, the SMF 160 may perform at least one function among session management (e.g., session establishment, modification, and release, including tunnel maintenance between the UPF 170 and the access network node), selection and control of a user plane (UP) function, a configuration of traffic steering for routing traffic from the UPE 170 to an appropriate destination, termination of an SM part of an NAS message, downlink data notification (DDN), and delivery of access network (AN)-specific SM information to the access network through the N2l interface via an initiator (e.g., AMF 150). Some or all functions of the SMF 160 may be supported within a single instance of one SMF 160.

In 3GPP systems, conceptual links connecting NFs in the 5G system may be referred to as “reference points”. The reference points may also be referred to as “interfaces”. The following exemplifies reference points (hereinafter interchangeably used with “interfaces”) included in the 5G system architecture represented throughout various embodiments of the disclosure.
N1: A reference point between a UE 110 and an AMF 150
N2: A reference point between an (R)AN 120 and an AMF 150
N3: A reference point between an (R)AN 120 and a UPF 170
N4: A reference point between an SMF 160 and a UPF 170
N5: A reference point between a PCF 180 and an AF 130
N6: A reference point between a UPF 170 and a DN 140
N7: A reference point between an SMF 160 and a PCF 180
N8: A reference point between a UDM 153 and an AMF 150
N9: A reference point between two core UPFs 170
N10: A reference point between a UDM 153 and an SMF 160
N11: A reference point between an AMF 150 and an SMF 160
N12: A reference point between an AMF 150 and an authentication server function (AUSF) 151
N13: A reference point between a UDM 153 and an AUSF 151
N14: A reference point between two AMFs 150
N15: A reference point between a PCF 180 and an AMF 150 for a non-roaming scenario, and a reference point between a PCF 180 in a visited network and an AMF 150 for a roaming scenario

FIG. 1B illustrates a wireless environment including a core network in a wireless communication system according to embodiments of the disclosure. Referring to FIG. 1B, the wireless communication system may include a radio access network (RAN) 120 and a core network (CN).

The radio access network 120 is a network directly connected to a user device, for example, the UE 110 and corresponds to infrastructure providing radio access to the UE 110. The radio access network 120 includes a set of a plurality of BSs including a BS 125, and the plurality of BSs may perform communication through an interface configured therebetween. At least some of the interfaces between the plurality of BSs may be wired or wireless. The BS 125 may have a structure in which a central unit (CU) and a distributed unit (DU) are separated. In this case, one CU may control a plurality of DUs. The BS 125 may be referred to as “access point (AP)”, “next generation node B (gNB)”, “5th-generation (5G) node”, “wireless point”, “transmission/reception point (TRP)”, or another term having a technical meaning equivalent thereto, as well as “base station”. The UE 110 accesses the radio access network 120 and communicates with the BS 125 through a radio channel. The UE 110 may be referred to as “user equipment (UE)”, “mobile station”, “subscriber station”, “remote terminal”, “wireless terminal”, “user device”, or other terms having the equivalent technical meaning, as well as “terminal”.

The core network is a network that manages the total system, and controls the radio access network 120 and processes data and control signals for the UE 110 transmitted and received through the radio access network 120. The core network may perform various functions such as the control of a user plane and a control plane, processing of mobility, management of subscriber information, charging, and interworking with other types of systems (for example, long-term evolution (LTE) system). In order to perform the various functions, the core network may include a plurality of functionally separated entities having different network functions (NFs). For example, the core network 200 may include the access and mobility management function (AMF) 150, the session management function (SMF) 160, the user plane function (UPF) 170, the policy and charging function (PCF) 180, the network repository function (NRF) 159, the unified data management (UDM) 153, the network exposure function (NEF) 155, and the unified data repository (UDR) 157.

The UE 110 may be connected to the radio access network 120 and may access the AMF 150 performing the mobility management function of the core network. The AMF 150 is a function or a device in charge of both the access of the radio access network 120 and the mobility management of the UE 110. The SMF 160 is an NF managing a session. The AMF 150 is connected to the SMF 160, and the AMF 150 routes a message related to a session for the UE 110 to the SMF 160. The SMF 160 is connected to the UPF 170, and allocates user plane resources to be provided to the UE 110 and establishes a tunnel for transmitting data between the BS 125 and the UPF 170. The PCF 180 controls information related to a policy and charging for a session used by the UE 110.

The NRF 159 performs a function of storing information on NFs installed in a mobile communication operator network and informing of the stored information. The NRF 159 may be connected to all NFs. When each NF operates in the operator network, the NF is registered in the NRF 159, so the NRF 159 is informed that the NF operates within the network. The UDM 153 is an NF playing a similar role to a home subscriber server (HSS) of the 4G network and stores subscription information of the UE 110 or context used by the UE 110 within the network.

The NEF 155 may serve to connect a 3rd party server with the NF within the 5G mobile communication system. Further, the NEF 155 serves to provide or update data to the UDR 157 or acquire data. The UDR 157 performs a function of storing subscription information of the UE 120, storing policy information, storing data exposed to the outside, or storing information required for a 3rd party application. Further, the UDR 157 serves to provide the stored data to another AF.

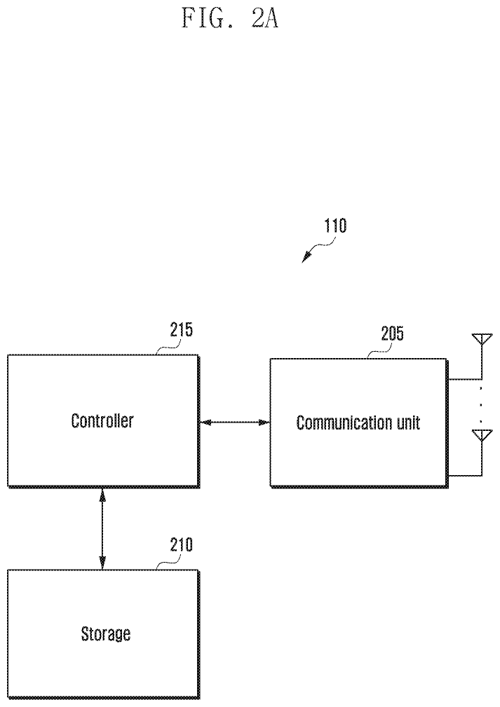

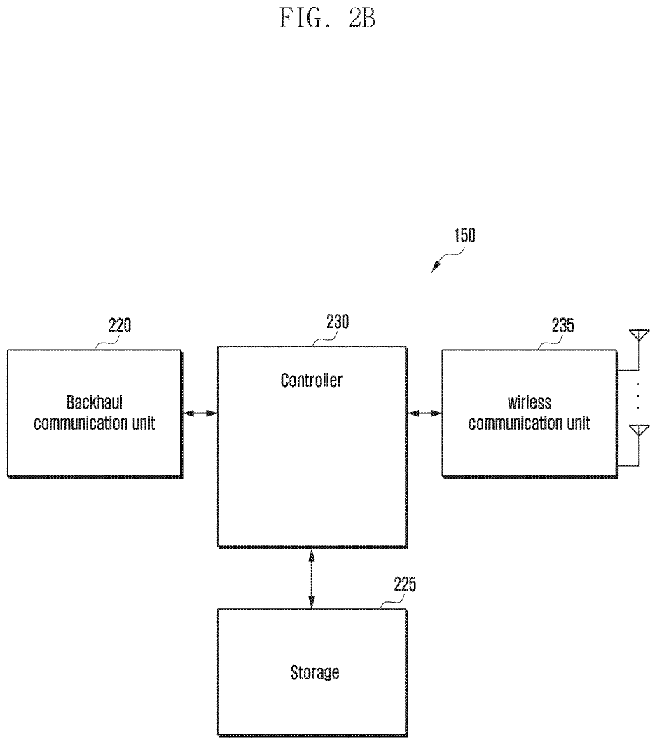

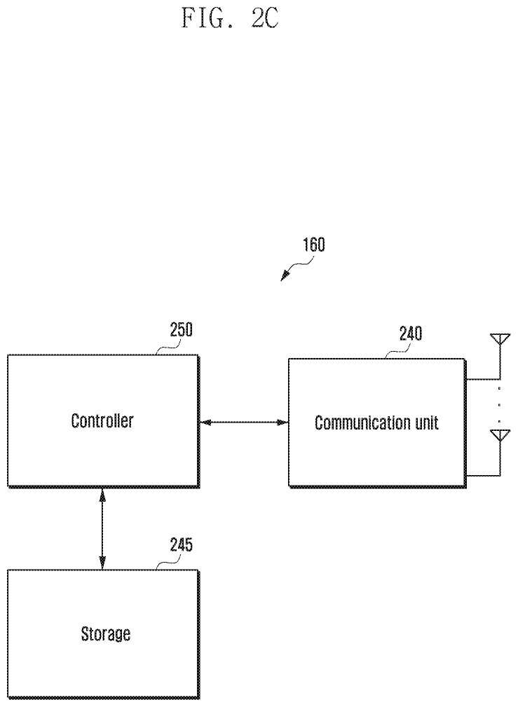

FIG. 2A illustrates an example of a functional structure of a UE according to embodiments of the disclosure. The structure illustrated in FIG. 2A may be understood as a structure of the UE 110. As used herein, such terms as “. . . unit” and “. . . er” refer to a unit configured to process at least one function or operation, and may be implemented as hardware, software, or a combination of hardware and software.

Referring to FIG. 2A, the UE may include a communication unit 205, a storage 210, and a controller 215.

The communication unit 205 performs functions for transmitting/receiving signals through a radio channel. For example, the communication unit 205 performs functions of conversion between baseband signals and bitstrings according to the physical layer specifications of the system. For example, during data transmission, the communication unit 205 generates complex symbols by encoding and modulating a transmission bitstream. In addition, during data reception, the communication unit 205 demodulates and decodes a baseband signal to restore a received bitstring. In addition, the communication unit 205 up-converts a baseband signal to an RF band signal, transmits the same through an antenna, and down-converts an RF band signal received through the antenna to a baseband signal. For example, the communication unit 205 may include a transmission filter, a reception filter, an amplifier, a mixer, an oscillator, a DAC, and an ADC.

In addition, the communication unit 205 may include multiple transmission/reception paths. Moreover, the communication unit 205 may include at least one antenna array including multiple antenna elements. In terms of hardware, the communication unit 205 may include a digital circuit and an analog circuit (e.g., a radio frequency integrated circuit (RFIC)). The digital circuit and the analog circuit may be implemented as a single package. In addition, the communication unit 205 may include multiple RF chains. Furthermore, the communication unit 205 may perform beamforming.

The communication unit 205 transmits and receives signals as described above. Accordingly, all or part of the communication unit 205 may be referred to as a “transmitter”, a “receiver”, or a “transceiver”. In addition, as used in the following description, the meaning of “transmission and reception performed through a radio channel” includes the meaning that the above-described processing is performed by the communication unit 205.

The storage 210 stores basic programs, application programs, and data, such as configuration information, for operation of the main base station. The storage 210 may include a volatile memory, a nonvolatile memory, or a combination of a volatile memory and a nonvolatile memory. In addition, the storage 210 provides the stored data at the request of the controller 215.

The controller 215 controls the overall operation of the UE. For example, the controller 215 transmits/receives signals through the communication unit 205. In addition, the controller 215 records data in the storage 210 and reads the data from the storage 210. In addition, the controller 215 may perform functions of protocol stacks required by communication specifications. To this end, the controller 215 may include at least one processor or microprocessor, or may be a part of a processor. In addition, a part of the communication unit 205 and the controller 215 may be referred to as a communication processor (CP). According to various embodiments, the controller 215 may control to perform synchronization by using a wireless communication network. For example, the controller 215 may control the UE to perform operations according to various embodiments as described below.

According to various embodiments of the disclosure, the UE may be configured by a mobile equipment (ME) and a universal mobile telecommunications service (UMTS) subscriber identity module (USIM). The ME may include a mobile terminal (MT) and a terminal equipment (TE). The MT may be a part in which a radio access protocol is operated, and the TE may be a part in which a control function is operated. For example, in the case of a wireless communication terminal (e.g., mobile phone), the MT and the TE may be integrated, and in the case of a notebook, the MT and the TE may be separated. As used herein, the ME and the TE may be represented as separate entities according to the operations of the respective components, but the disclosure is not limited thereto, and it will be apparent that, in describing various embodiments of the disclosure, the ME and the TE may be collectively represented as the terminal (e.g., UE) or the ME may be represented as the terminal.

FIG. 2B illustrates an example of a functional structure of a base station according to embodiments of the disclosure. The structure illustrated in FIG. 2B may be understood as a structure of the base station 120. As used herein, such terms as “. . . unit” and “. . . er” refer to a unit configured to process at least one function or operation, and may be implemented as hardware, software, or a combination of hardware and software.

Referring to FIG. 2A, the base station includes a wireless communication unit 235, a backhaul communication unit 220, a storage 225, and a controller 230.

The wireless communication unit 235 performs functions for transmitting/receiving signals through a radio channel. For example, the wireless communication unit 235 performs functions of conversion between baseband signals and bitstrings according to the physical layer specifications of the system. For example, during data transmission, the wireless communication unit 235 encodes and modulates a transmitted bitstring to generate complex symbols. In addition, during data reception, the wireless communication unit 235 demodulates and decodes a baseband signal to reconstruct a received bitstring.

In addition, the wireless communication unit 235 up-converts a baseband signal to an RF band signal, transmits the same through an antenna, and down-converts an RF band signal received through the antenna to a baseband signal. To this end, the wireless communication unit 235 may include a transmission filter, a reception filter, an amplifier, a mixer, an oscillator, a digital to analog converter (DAC), an analog to digital converter (ADC), and the like. In addition, the wireless communication unit 235 may include multiple transmission/reception paths. Furthermore, the wireless communication unit 235 may include at least one antenna array including multiple antenna elements.

In terms of hardware, the wireless communication unit 235 may include a digital unit and an analog unit, and the analog unit may include multiple sub-units according to operation power, frequencies, etc. The digital unit may be implemented as at least one processor (e.g., a digital signal processor (DSP)).

The wireless communication unit 235 transmits and receives signals as described above. Accordingly, all or part of the wireless communication unit 235 may be referred to as a “transmitter”, a “receiver”, or a “transceiver”. In addition, as used in the following description, the meaning of “transmission and reception performed through a radio channel” includes the meaning that the above-described processing is performed by the wireless communication unit 235.

The backhaul communication unit 220 provides an interface for performing communication with other nodes in the network. That is, the backhaul communication unit 220 converts a bitstring, transmitted from the base station to any other node, for example, any other access node, any other base station, an upper node, or a core network, into a physical signal, and converts a physical signal, received from any other node, into a bitstring.

The storage 225 may store basic programs, application programs, and data, such as configuration information, for operation of the main base station. The storage 225 may include a volatile memory, a nonvolatile memory, or a combination of a volatile memory and a nonvolatile memory. In addition, the storage 225 provides the stored data at the request of the controller 230.

The controller 230 controls the overall operation of the base station. For example, the controller 230 transmits/receives signals through the wireless communication unit 235 or the backhaul communication unit 220. In addition, the controller 230 records data in the storage 225 and reads the data from the storage 225. Furthermore, the controller 230 may perform functions of protocol stacks required by communication specifications. According to another embodiment, the protocol stacks may be included in the wireless communication unit 235. To this end, the controller 230 may include at least one processor. According to various embodiments, the controller 230 may control to perform synchronization by using a wireless communication network. For example, the controller 230 may control the base station to perform operations according to various embodiments as described below.

FIG. 2C illustrates an example of a functional structure of a core network entity according to embodiments of the disclosure. A structure of a core network entity in a wireless communication system according to various embodiments of the disclosure is illustrated. The structure illustrated in FIG. 2C may be understood as a structure of a device having at least one function among network entities including the ANF 150 in FIG. 1. As used herein, such terms as “. . . unit” and “. . . er” refer to a unit configured to process at least one function or operation, and may be implemented as hardware, software, or a combination of hardware and software.

Referring to FIG. 2C, the core network entity may include a communication unit 240, a storage 245, and a controller 250.

The communication unit 240 provides an interface for communicating with other devices in the network. That is, the communication unit 240 converts a bitstring, transmitted from the core network entity to any other device, into a physical signal, and converts a physical signal, received from any other device, into a bitstring. The communication unit 240 may transmit/receive signals. Accordingly, the communication unit 240 may be referred to as a modem, a transmitter, a receiver, or a transceiver. The communication unit 240 enables the core network entity to communicate with other devices or the system via a backhaul connection (e.g., wired backhaul or wireless backhaul) or via a network.

The storage unit 245 may store basic programs, application programs, and data, such as configuration information, for operations of the core network entity. The storage 245 may include a volatile memory, a nonvolatile memory, or a combination of a volatile memory and a nonvolatile memory. In addition, the storage 245 provides the stored data at the request of the controller 250.

The controller 250 controls the overall operation of the core network entity. For example, the controller 250 transmits/receives signals through the communication unit 240. In addition, the controller 250 records data in the storage 245 and reads the data from the storage 245. To this end, the controller 250 may include at least one processor. According to various embodiments, the controller 250 may control to perform synchronization by using a wireless communication network. For example, the controller 250 may control the core network entity to perform operations according to various embodiments as described below.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

In the following description of the disclosure, terms and names defined in 5GS and NR standards, which are the latest standards specified by the 3GPP group among the existing communication standards, will be used for the sake of descriptive convenience. However, the disclosure is not limited by these terms and names, and may be applied in the same way to systems that conform other standards. In particular, the disclosure may be applied to the 5th generation mobile communication standards (e.g., 5GS and NR).

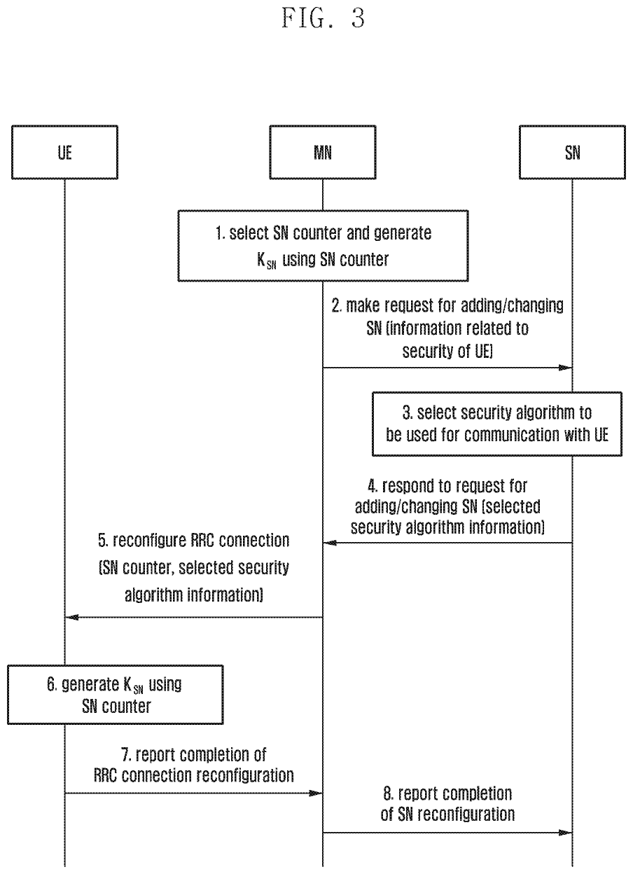

FIG. 3 is a diagram illustrating a method of managing keys in dual connectivity according to an embodiment of the disclosure.

A master node (MN) illustrated in FIG. 3 may be a master BS connected to the UE. The MN may have an encryption key (abbreviated as a security key or a key) K_{MN} for secure communication with the UE.

A secondary node (SN) illustrated in FIG. 3 may be a secondary BS connected to the UE for dual connectivity. The SN may acquire a key K_{SN} for secure communication with the UE through the procedure described below.

Hereinafter, individual description for operations to be performed is made. Hereinafter, it is disclosed as if respective operations are sequentially performed, but the order of the operations may be changed if it works even though the order of the operations is changed.

In operation 1, the MN may perform one or more of the following processes.
The MN may select an SN counter value. For example, the MN may select an SN counter value by generating the SN counter value. The SN counter is a constant and may be a value associated with a key to be transferred to the SN described below. The SN counter should be a different value for every SN to be connected. The SN counter should be a different value whenever a connection is newly established even though the connected SN is the same.
The MN may generate K_{SN} to be transferred to the SN. K_{SN} may be generated using K_{MN} and the selected SN counter value. For example, K_{SN} may be a key value generated through the output with K_{MN} and the selected SN counter value as the input of a key derivation function (KDF).

In operation 2, the MN may perform one or more of the following processes.
The MN may transmit the K_{SN} generated in operation 1 to the SN.
The MN may transmit information related to security of the UE to the SN. For example, the MN may transmit the type of security algorithms available by the UE to the SN. For example, the MN may transmit a policy related to a security method to be used by the UE to the SN.

In operation 3, the SN may perform one or more of the following processes.
The SN may select a security algorithm to be used in secure communication with the UE.
The SN may induce keys to be used with the UE from the received K_{SN}. During the induction process, the key corresponding to the selected security algorithm may be induced.
The SN may select the security method to be used with the UE, based on the security policy received in operation 2.

In operation 4, the SN may perform one or more of the following processes.
The SN may transmit a security algorithm selected by the SN itself to the MN.
The SN may transmit a security method being used by the SN itself.

In operation 5, the MN may perform one or more of the following processes.
The MN may transmit the SN counter value selected in operation 1 to the UE.
The MN may transmit the information received from the SN in operation 4 to the UE.

In operation 6, the UE may perform one or more of the following processes.
The UE may generate K_{SN} by using K_{MN} possessed by the UE itself and the SN counter value received in operation 5.

In operation 7, the UE may inform the MN that the task has been completed.

In operation 8, the MN may inform the SN that the task has been completed.

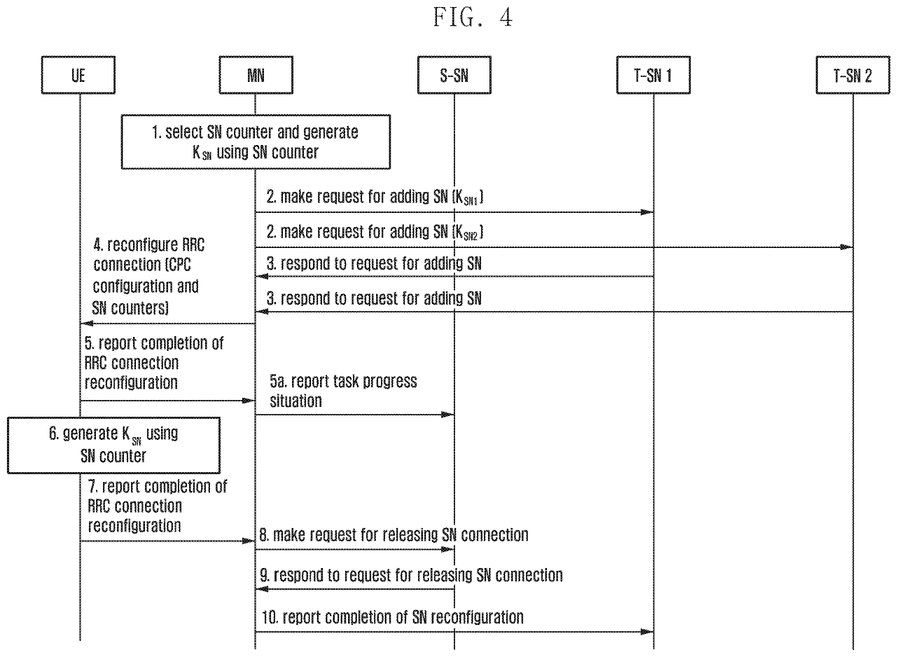

FIG. 4 is a diagram illustrating a procedure of changing a secondary node in dual connectivity, based on the method illustrated in FIG. 3.

A master node (MN) illustrated in FIG. 4 may be a master BS connected to the UE. The MN may have a key K_{MN} for secure communication with the UE.

A source-secondary node (S-SN) illustrated in FIG. 4 may be a secondary BS connected to the UE for dual connectivity. The S-SN may have a key K_{SN} for secure communication with the UE.

A plurality of target-secondary nodes (T-SNs) illustrated in FIG. 4 may be candidate secondary BSs to be connected to the UE on behalf of the S-SN for dual connectivity. The T-SN may acquire the key K_{SN} for secure communication with the UE through the procedure described below.

The procedure of FIG. 4 is disclosed based on the procedure of FIG. 3. In other words, the majority of the procedure in FIG. 4 corresponds to the procedure illustrated in FIG. 3. Accordingly, for readability, the content already illustrated in FIG. 3 may not be described in the content of FIG. 4.

Hereinafter, individual description for operations to be performed is made. Hereinafter, it is disclosed as if respective operations are sequentially performed, but the order of the operations may be changed if it works even though the order of the operations is changed.

In operation 1, the MN may perform one or more of the following processes.
The MN may select an SN counter value. The SN counter should be a different value for every SN to be connected. The SN counter should be a different value whenever a connection is newly established even though the connected SN is the same.
The MN may generate K_{SN} to be transferred to the T-SN. Each K_{SN} may be generated using a value of one of the selected SN counters.

In operation 2, the MN may perform one or more of the following processes.
The MN may perform a procedure corresponding to operation 2 in FIG. 3 to the T-SN.

In operation 3, the T-SNs may perform one or more of the following processes.
Each T-SN may perform a procedure corresponding to operation 4 in FIG. 3 to the MN.

In operation 4, the MN may perform one or more of the following processes.
The MN may provide a list of the selected T-SNs to the UE.
The MN may provide condition information indicating when each T-SN can be selected to the UE. The information may be included as a portion of the conditional PSCell change (CPC) configuration.
The MN may provide SN counter values corresponding to K_{SN} allocated to each T-SN to the UE. Thereafter, the UE may determine which T-SN has the generated K_{SN} and which SN counter value is used to generate K_{SN} through the information.

In operation 5, the UE may inform the MN that the task has been completed.

In operation 5a, the MN may inform the S-SN of the process situation of the task. For example, the MN may inform the S-SN that the UE has received the CPC configuration.

In operation 6, the UE may perform one or more of the following processes.
The UE may select a T-SN to replace the S-SN, based on the information received in operation 4. For example, the UE may select a replaceable T-SN from among the received T-SN list, based on the received condition information (for example, CPC configuration).
The UE may generate a key K_{SN} to be used for secure communication with the selected T-SN by using K_{MN} possessed by the UE itself and the SN counter value received in operation 4.

In operation 7, the UE may inform the MN that the task has been completed. At this time, one or more pieces of the following information may be transmitted to the MN.
The UE may transmit information that may refer to a T-SN to be connected to the UE itself to the MN.

In operation 8, the MN may make a request for releasing the connection to the S-SN.

In operation 9, the S-SN may inform the MN that the connection has been released.

In operation 10, the MN may inform the T-SN to be connected to the UE that the task has been completed.

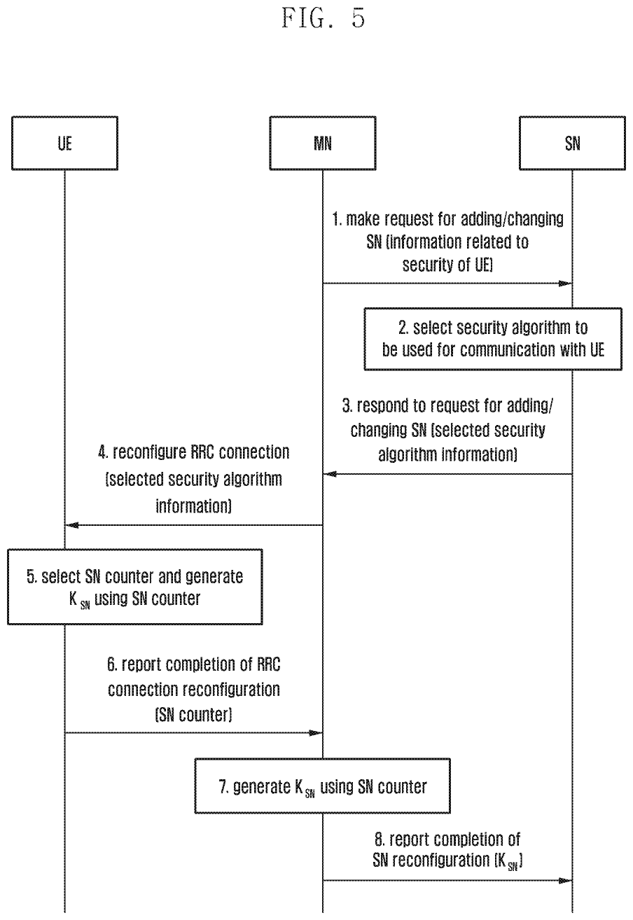

FIG. 5 is a diagram illustrating another method of managing keys in dual connectivity according to an embodiment of the disclosure.

A master node (MN) illustrated in FIG. 5 may be a master BS connected to the UE. The MN may have an encryption key (abbreviated as a security key or a key) K_{MN} for secure communication with the UE.

A secondary node (SN) illustrated in FIG. 5 may be a secondary BS connected to the UE for dual connectivity. The SN may acquire a key K_{SN} for secure communication with the UE through the procedure described below.

Hereinafter, individual description for operations to be performed is made. Hereinafter, it is disclosed as if respective operations are sequentially performed, but the order of the operations may be changed if it works even though the order of the operations is changed.

In operation 1, the MN may perform one or more of the following processes.
The MN may transmit information related to security of the UE to the SN. For example, the MN may transmit the type of security algorithms available by the UE to the SN. For example, the MN may transmit a policy related to a security method to be used by the UE to the SN.

In operation 2, the SN may perform one or more of the following processes.
The SN may select a security algorithm to be used in secure communication with the UE.
The SN may select the security method to be used with the UE, based on the security policy received in operation 2.

In operation 3, the SN may perform one or more of the following processes.
The SN may transmit a security algorithm selected by the SN itself to the MN.
The SN may transmit a security method used by the SN itself.

In operation 4, the MN may perform one or more of the following processes.
The MN may transmit the information received from the SN in operation 4 to the UE.

In operation 5, the UE may perform one or more of the following processes.
The UE may select an SN counter value. For example, the MN may generate the SN counter value and select the SN counter value. The SN counter is a constant and may be a value associated with a key to be transferred to the SN described below. The SN counter should be a different value for every SN to be connected. The SN counter should be a different value whenever a connection is newly established even though the connected SN is the same.
The UE may generate K_{SN} by using K_{MN} possessed by the UE itself and the selected SN counter value. For example, K_{SN} may be a key value generated through the output with K_{MN} and the selected SN counter value as the input of a key derivation function (KDF).

In operation 6, the UE may inform the MN that the task has been completed. At this time, the UE may additionally perform one or more of the following processes.
The UE may transmit the SN counter value selected in operation 5 to the MN.

In operation 7, the MN may perform one or more of the following processes.
The MN may generate K_{SN} to be transferred to the SN. K_{SN} may be generated using K_{MN} and the SN counter value received in operation 6.

In operation 8, the MN may inform the SN that the task has been completed. At this time, the MN may additionally perform one or more of the following processes.
The MN may transmit the K_{SN} generated in operation 7 to the SN.

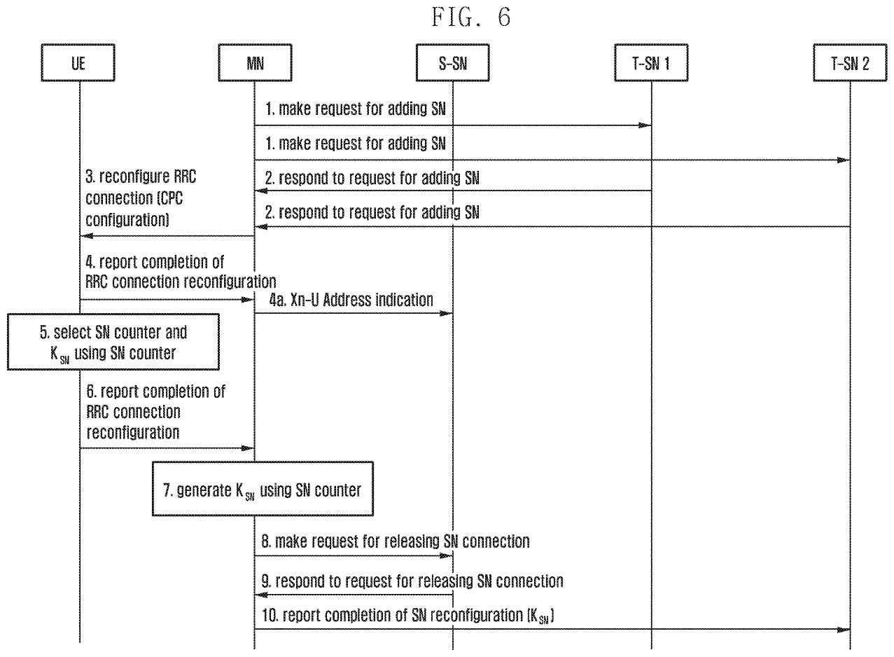

FIG. 6 is a diagram illustrating a procedure of changing a secondary node in dual connectivity, based on the method illustrated in FIG. 5.

A master node (MN) illustrated in FIG. 6 may be a master BS connected to the UE. The MN may have a key K_{MN} for secure communication with the UE.

A source-secondary node (S-SN) illustrated in FIG. 6 may be a secondary BS connected to the UE for dual connectivity. The S-SN may have a key K_{SN} for secure communication with the UE.

The target-secondary nodes (T-SNs) illustrated in FIG. 6 may be candidate secondary BSs to be connected to the UE on behalf of the S-SN for dual connectivity. The T-SN may acquire the key K_{SN} for secure communication with the UE through the procedure described below.

The procedure of FIG. 6 is disclosed based on the procedure of FIG. 5. In other words, the majority of the procedure in FIG. 6 corresponds to the procedure illustrated in FIG. 5. Accordingly, for readability, the content already illustrated in FIG. 5 may not be described in the content of FIG. 6.

Hereinafter, individual description for operations to be performed is made. Hereinafter, it is disclosed as if respective operations are sequentially performed, but the order of the operations may be changed if it works even though the order of the operations is changed.

In operation 1, the MN may perform one or more of the following processes.
The MN may perform a procedure corresponding to operation 1 in FIG. 5 to the T-SN.

In operation 2, the T-SNs may perform one or more of the following processes.
Each T-SN may perform a procedure corresponding to operation 3 in FIG. 5 to the MN.

In operation 3, the MN may perform one or more of the following processes.
The MN may provide a list of the selected T-SNs to the UE.
The MN may provide condition information indicating when each T-SN can be selected to the UE. The information may be included as a portion of the conditional PSCell change (CPC) configuration.

In operation 4, the UE may inform the MN that the task has been completed.

In operation 4a, the MN may inform the S-SN of the process situation of the task. For example, the MN may inform the S-SN that the UE has received the CPC configuration.

In operation 5, the UE may perform one or more of the following processes.
The UE may select a T-SN to replace the S-SN, based on the information received in operation 3. For example, the UE may select a replaceable T-SN from among the received T-SN list, based on the received condition information (for example, CPC configuration).
The UE may select an SN counter value to be used for generating a key to be used for secure communication with the selected T-SN.
The UE may generate a key K_{SN} to be used for secure communication with the selected T-SN by using K_{MN} possessed by the UE itself and the selected SN counter value.

In operation 6, the UE may inform the MN that the task has been completed. At this time, the UE may additionally perform one or more of the following processes.
The UE may transmit information that may refer to a T-SN to be connected to the UE itself to the MN.
The UE may transmit the SN counter value selected in operation 5.

In operation 7, the MN may perform one or more of the following processes.
The MN may generate K_{SN} to be transferred to the T-SN to be connected to the UE. K_{SN} may be generated using K_{MN} and the SN counter value received in operation 6.

In operation 8, the MN may make a request for releasing the connection to the S-SN.

In operation 9, the S-SN may inform the MN that the connection has been released.

In operation 10, the MN may inform the T-SN to be connected to the UE that the task has been completed. At this time, the MN may additionally perform one or more of the following processes.
The MN may transmit K_{SN} generated in operation 7 to the T-SN.

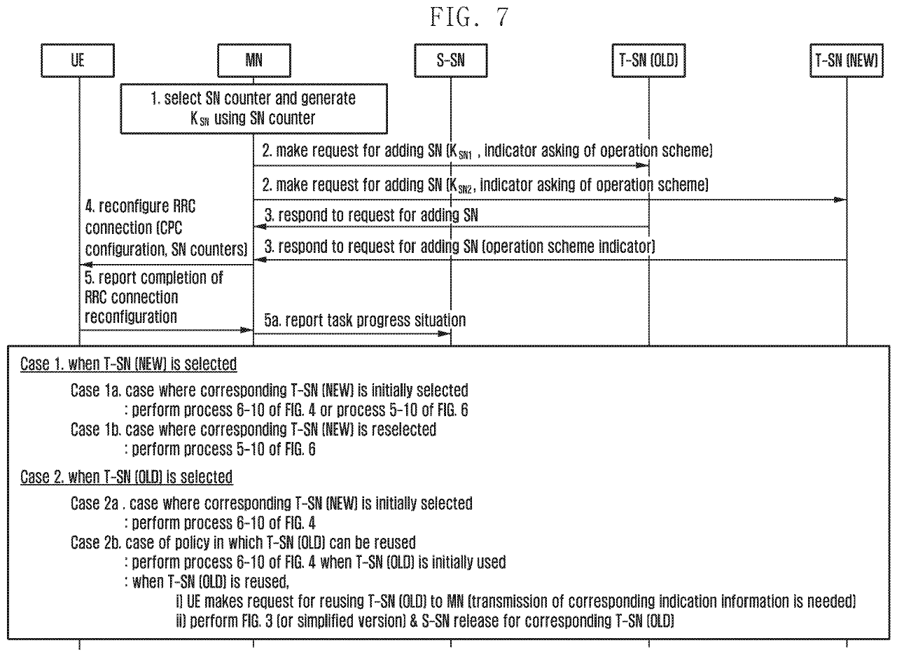

FIG. 7 is a diagram illustrating a procedure of continuously changing a secondary node in dual connectivity by linking the two methods illustrated in FIGS. 3 and 5.

A master node (MN) illustrated in FIG. 7 may be a master BS connected to the UE. The MN may have a key K_{MN} for secure communication with the UE.

A source-secondary node (S-SN) illustrated in FIG. 7 may be a secondary BS connected to the UE for dual connectivity. The S-SN may have a key K_{SN} for secure communication with the UE.

The target-secondary nodes (T-SNs) illustrated in FIG. 7 may be candidate secondary BSs to be connected to the UE on behalf of the S-SN for dual connectivity. The T-SN may acquire the key K_{SN} for secure communication with the UE through the procedure described below. At this time, a T-SN (OLD) may mean the SN operating in the scheme illustrated in FIG. 3. At this time, a T-SN (NEW) may mean the SN operating in the scheme illustrated in FIG. 5. The T-SN (OLD) may mean the SN that does not support a selective SCG function described below, the T-SN (NEW) may mean the SN that supports the selective SCG function described below.

The term selective SCG is defined. Through FIGS. 4 and 6, the process in which the UE receives CPS configuration information from the MN and replaces the SN by using the same was illustrated. The selective SCG is a technique in which the UE continuously replaces the SN by using the received CPC configuration information. In other words, it means a technique that, when the UE replaces the SN by using the CPC configuration after receiving the CPC configuration from the MN, and desires to replace again the SN with a new SN in the future, repeats a process of replacing the SN to the new SN by using the already received CPC configuration without receiving the CPC configuration from the MN again. When the selective SCG technique is used, one SN may be selected several times by the UE.

The procedure of FIG. 7 is disclosed based on the procedures of FIGS. 3 and 5. In other words, the majority of the procedure in FIG. 7 corresponds to the procedure illustrated in FIGS. 3 and 5. Accordingly, for readability, the content already illustrated in FIGS. 3 and 5 may not be described in the content of FIG. 7.

Hereinafter, individual description for operations to be performed is made. Hereinafter, it is disclosed as if respective operations are sequentially performed, but the order of the operations may be changed if it works even though the order of the operations is changed.

In operation 1, the MN may perform one or more of the following processes.
The MN may select an SN counter value. The SN counter should be a different value for every SN to be connected. The SN counter should be a different value whenever a connection is newly established even though the connected SN is the same.
The MN may generate K_{SN} to be transferred to the T-SN. Each K_{SN} may be generated using a value of one of the selected SN counters.

In operation 2, the MN may perform one or more of the following processes.
The MN may perform a procedure corresponding to operation 2 in FIG. 3 to the T-SN.
The MN may transmit an indicator asking each T-SN how it operates. That is, the MN may transmit an indicator asking about whether the corresponding T-SN operates in the scheme illustrated in FIG. 3 or the scheme illustrated in FIG. 5. Such an operation may be interpreted to be the same as transmitting an indicator asking about whether the corresponding T-SN supports the selective SCG function. When the MN knows in advance how the counterpart T-SN operates (or which function is supported), the transmission of the indicator may be omitted. Such an indicator may be understood as a request message for information on the operation scheme of the T-SN or information on whether the selective SCG function is supported.

In operation 3, the T-SNs may perform one or more of the following processes.
Each T-SN may perform a procedure corresponding to operation 4 in FIG. 3 or operation 3 in FIG. 5 to the MN.
When the corresponding T-SN is the SN operating in the scheme illustrated in FIG. 5, the T-SN may transmit an indicator indicating that the T-SN itself is the SN operating in the scheme illustrated in FIG. 5. Alternatively, when the corresponding T-SN is the SN operating in the scheme illustrated in FIG. 5 and receives the indicator asking about the operation scheme from the MN in operation 2, the T-SN may transmit the indicator indicating that the T-SN itself is the SN operating in the scheme illustrated in FIG. 5. Such indicators may be information on the operation scheme of each T-SN or information itself on whether the selective SCG function is supported.

In operation 4, the MN may perform one or more of the following processes.
The MN may provide a list of the selected T-SNs to the UE.
The MN may provide condition information indicating when each T-SN can be selected to the UE. The information may be included as a portion of the conditional PSCell change (CPC) configuration.
The MN may provide K_{SN} allocated to each T-SN and corresponding SN counter values to the UE. Thereafter, the UE may determine which T-SN has the generated K_{SN} and which SN counter value is used to generate K_{SN} through the information.
The MN may inform the UE of a function supported by each T-SN. For example, the ME may transmit information on whether each T-SN is the SN operating in the scheme illustrated in FIG. 3 or the SN operating in the scheme illustrated in FIG. 5 to the UE. This may be interpreted to be the same as informing whether or not the corresponding T-SN is the SN supporting the selective SCG function. The information may be included as a portion of the conditional PSCell change (CPC) configuration.
The MN may provide policy information containing whether the SN operating in the scheme illustrated in FIG. 3 can be reused to the UE. The SN operating in the scheme illustrated in FIG. 3 basically does not support the selective SCG, and accordingly, the corresponding SN cannot be continuously selected without any additional task. In other words, in order to reuse the SN operating in the scheme illustrated in FIG. 3, an additional task is needed. The policy information may include whether the additional task is allowed. The policy information may be included as a portion of the conditional PSCell change (CPC) configuration.

In operation 5, the UE may inform the MN that the task has been completed.

In operation 5a, the MN may inform the S-SN of the process situation of the task. For example, the MN may inform the S-SN that the UE has received the CPC configuration.

Thereafter, a process of making the selective SCG is described.

### CASE1. Selected T-SN Based on FIG. 5

When the corresponding T-SN is initially selected or reselected, operations 5 to 10 illustrated in FIG. 6 may be performed.
When the corresponding T-SN is initially selected, operations 6 to 10 illustrated in FIG. 4 may be performed.

### CASE2. Selected T-SN Based on FIG. 3 & Non-Reuse Policy

The corresponding T-SN can be selected only once in which case operations 6 to 10 illustrated in FIG. 4 may be performed.

### CASE3. Selected T-SN Based on FIG. 3 & Reuse Policy

When the corresponding T-SN is initially selected, operations 6 to 10 illustrated in FIG. 4 may be performed.
When the corresponding T-SN is reselected, the following process may be performed. The UE may make a request for the connection with the corresponding T-SN to the MN. At this time, the UE may transmit a series of information required for allowing the MN to recognize that “the corresponding T-SN operates based on FIG. 3 and was reselected”. For example, the UE may additionally transmit information on “the fact that the corresponding T-SN operates based on FIG. 3” and/or “the fact that the corresponding T-SN was reselected” to the MN. When the MN already knew the information, the transmission of the information may be omitted. Further, one of the following processes may be additionally performed.
Operations 1 to 8 in FIG. 3 may be performed. In addition, a procedure (operations 8 to 9 in FIG. 4) of releasing the S-SN may be performed.
Operations 5 to 7 in FIG. 5 may be performed. Thereafter, operations 2 to 4 in FIG. 3 may be performed. Next, operation 8 in FIG. 3 may be performed. In addition, a procedure (operations 8 to 9 in FIG. 4) of releasing the S-SN may be performed.

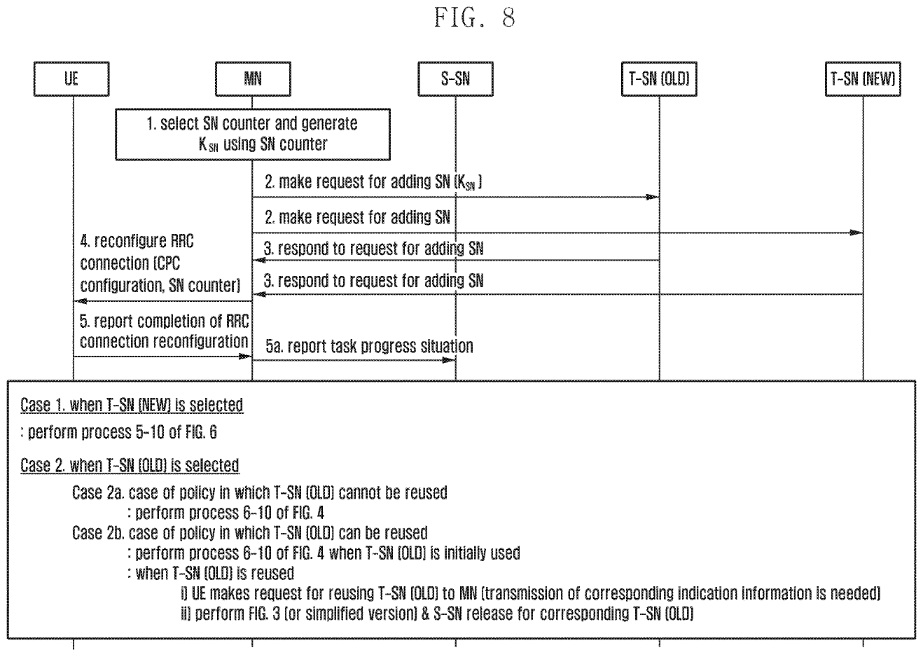

FIG. 8 is a diagram illustrating another procedure of continuously changing a secondary node in dual connectivity by linking the two methods illustrated in FIGS. 3 and 5.

A master node (MN) illustrated in FIG. 8 may be a master BS connected to the UE. The MN may have a key K_{MN} for secure communication with the UE.

A source-secondary node (S-SN) illustrated in FIG. 8 may be a secondary BS connected to the UE for dual connectivity. The S-SN may have a key K_{SN} for secure communication with the UE.

The target-secondary nodes (T-SNs) illustrated in FIG. 8 may be candidate secondary BSs to be connected to the UE on behalf of the S-SN for dual connectivity. The T-SN may acquire the key K_{SN} for secure communication with the UE through the procedure described below. At this time, the T-SN (OLD) may mean the SN operating in the manner illustrated in FIG. 3. At this time, a T-SN (NEW) may mean the SN operating in the manner illustrated in FIG. 5. The T-SN (OLD) may mean the SN that does not support a selective SCG function described below, the T-SN (NEW) may mean the SN that supports the selective SCG function described below.

The procedure of FIG. 8 is disclosed based on the procedures of FIGS. 3 and 5. In other words, the majority of the procedure in FIG. 8 corresponds to the procedure illustrated in FIGS. 3 and 5. Accordingly, for readability, the content already illustrated in FIGS. 3 and 5 may not be described in the content of FIG. 8.

Hereinafter, individual description for operations to be performed is made. Hereinafter, it is disclosed as if respective operations are sequentially performed, but the order of the operations may be changed if it works even though the order of the operations is changed.

In operation 1, the MN may perform one or more of the following processes.
The MN may select SN counter values for the T-SN (OLD). The SN counter should be a different value for every SN. Further, despite of the same SN, if the SN is newly connected, the SN counter may have to be new value.
The MN may generate K_{SN} to be transferred to the T-SN (OLD). Each K_{SN} may be generated using a value of one of the selected SN counters.

In operation 2, the MN may perform one or more of the following processes.
The MN may perform a procedure corresponding to operation 2 in FIG. 3 to the T-SN (OLD).
The MN may perform a procedure corresponding to operation 1 in FIG. 5 to the T-SN (NEW).

In operation 3, the T-SNs may perform one or more of the following processes.
Each T-SN may perform a procedure corresponding to operation 4 in FIG. 3 or operation 3 in FIG. 5 to the MN.

In operation 4, the MN may perform one or more of the following processes.
The MN may provide a list of the selected T-SNs to the UE.
The MN may provide condition information indicating when each T-SN can be selected to the UE. The information may be included as a portion of the conditional PSCell change (CPC) configuration.
The MN may provide SN counter values corresponding to K_{SN} allocated to each T-SN (OLD) to the UE. Thereafter, the UE may determine which T-SN (OLD) has the generated K_{SN} and which SN counter value is used to generate K_{SN} through the information.
The MN may transmit information on the function supported by each T-SN to the UE. For example, the ME may transmit information on whether each T-SN is the SN operating in the scheme illustrated in FIG. 3 or the SN operating in the scheme illustrated in FIG. 5 to the UE. This may be interpreted to be the same as informing whether or not the corresponding T-SN is the SN supporting the selective SCG function. The information may be included as a portion of the conditional PSCell change (CPC) configuration.
The MN may transmit policy information containing whether the SN operating in the scheme illustrated in FIG. 3 can be reused to the UE. A more detailed description thereof will be referred to the description of FIG. 7. The information may be included as a portion of the conditional PSCell change (CPC) configuration.

In operation 5, the UE may inform the MN that the task has been completed.

In operation 5a, the MN may inform the S-SN of the process situation of the task. For example, the MN may inform the S-SN that the UE has received the CPC configuration.

Thereafter, a process of making the selective SCG is described.

### CASE1. Selected T-SN Based on FIG. 5

Operations 5 to 10 in FIG. 6 may be performed.

### CASE2. Selected T-SN Based on FIG. 3 & Non-Reuse Policy

The corresponding T-SN can be selected only once in which case operations 6 to 10 illustrated in FIG. 4 may be performed.

### CASE3. Selected T-SN Based on FIG. 3 & Reuse Policy

When the corresponding T-SN is initially selected, operations 6 to 10 illustrated in FIG. 4 may be performed.
When the corresponding T-SN is reselected, the following process may be performed. The UE may make a request for the connection with the corresponding T-SN to the MN. At this time, the UE may transmit a series of information required for allowing the MN to recognize that “the corresponding T-SN operates based on FIG. 3 and is reselected”. For example, the UE may additionally transmit information on “the fact that the corresponding T-SN operates based on FIG. 3” and/or “the fact that the corresponding T-SN was reselected” to the MN. When the MN already knew the information, the transmission of the information may be omitted. Further, one of the following processes may be additionally performed.
Operations 1 to 8 in FIG. 3 may be performed. In addition, a procedure (operations 8 to 9 in FIG. 4) of releasing the S-SN may be performed.
Operations 5 to 7 in FIG. 5 may be performed. Thereafter, operations 2 to 4 in FIG. 3 may be performed. Next, operation 8 in FIG. 3 may be performed. In addition, a procedure (operations 8 to 9 in FIG. 4) of releasing the S-SN may be performed.

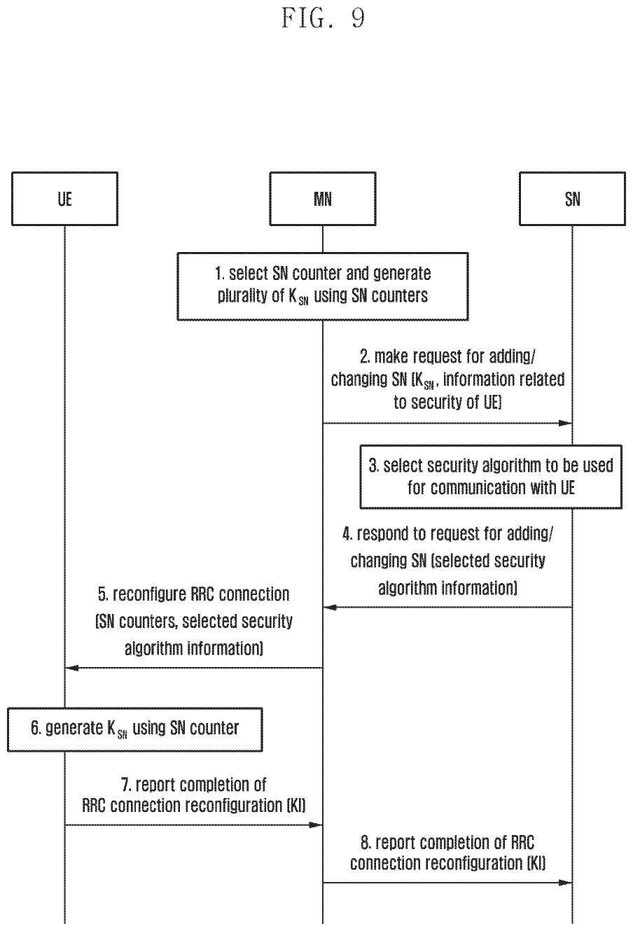

FIG. 9 is a diagram illustrating another method of managing keys in dual connectivity according to an embodiment of the disclosure.

A master node (MN) illustrated in FIG. 9 may be a master BS connected to the UE. The MN may have an encryption key (abbreviated as a security key or a key) K_{MN} for secure communication with the UE.

A secondary node (SN) illustrated in FIG. 9 may be a secondary BS connected to the UE for dual connectivity. The SN may acquire a key K_{SN} for secure communication with the UE through the procedure described below.

Hereinafter, individual description for operations to be performed is made. Hereinafter, it is disclosed as if respective operations are sequentially performed, but the order of the operations may be changed if it works even though the order of the operations is changed.

In operation 1, the MN may perform one or more of the following processes.
The MN may select an SN counter value. For example, the MN may generate the SN counter value and select the SN counter value. The SN counter is a constant and may be a value associated with a key to be transferred to the SN described below.
The MN may generate K_{SN} to be transferred to the SN. Each K_{SN} may be generated using K_{MN} and one of the selected SN counter values. For example, K_{SN} may be a key value generated through the output with K_{MN} and one of the selected SN counter values as the input of a key derivation function (KDF).

In operation 2, the MN may perform one or more of the following processes.
The MN may transmit K_{SN} generated in operation 1 to the SN.
The MN may transmit information related to security of the UE to the SN. For example, the MN may transmit the type of security algorithms available by the UE to the SN. For example, the MN may transmit a policy related to a security method to be used by the UE to the SN.

In operation 3, the SN may perform one or more of the following processes.
The SN may select a security algorithm to be used in secure communication with the UE.
The SN may induce keys to be used with the UE from the received K_{SN}. During the induction process, the key corresponding to the selected security algorithm may be induced.
The SN may select the security method to be used with the UE, based on the security policy received in operation 2.

In operation 4, the SN may perform one or more of the following processes.
The SN may transmit a security algorithm selected by the SN itself to the MN.
The SN may transmit a security method used by the SN itself.

In operation 5, the MN may perform one or more of the following processes.
The MN may transmit the SN counter values selected in operation 1.
The MN may transmit the information received from the SN in operation 4 to the UE.

In operation 6, the UE may perform one or more of the following processes.
The UE may select one of the received SN counter values.
The UE may generate K_{SN} by using K_{MN} possessed by the UE itself and the selected SN counter value.

In operation 7, the UE may inform the MN that the task has been completed. At this time, one of the following processes may be performed.
The UE may transmit information (being marked as KI in the drawing) that refers to the SN counter value selected by the UE itself in operation 6 to the MN. The information may be the SN counter value selected by the UE itself in operation 6. The information may be third information that may specific the SN counter value selected by the UE itself in operation 6. If the MN can determine which SN counter value has been selected by the UE without transmission of the information, the transmission of the information may be omitted.

In operation 8, the MN may inform the SN that the task has been completed. At this time, one of the following processes may be performed.
The MN may transmit information that refers to K_{MN} corresponding to the SN counter value selected by the UE in operation 6 to the SN. If it can be determined which SN counter value has been selected without transmission of the information, the transmission of the information may be omitted.

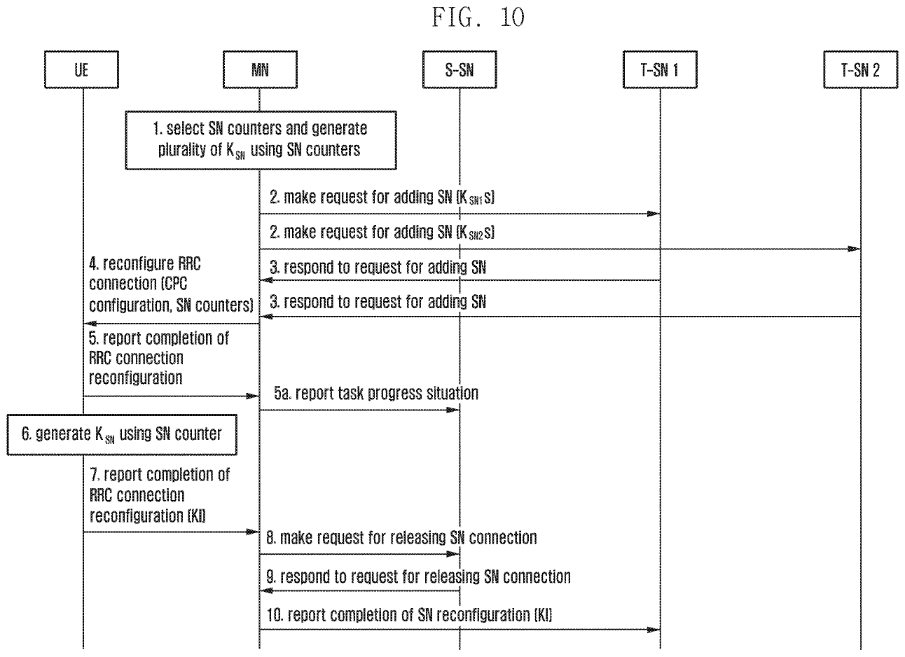

FIG. 10 is a diagram illustrating a procedure of changing a secondary node in dual connectivity, based on the method illustrated in FIG. 9.

A master node (MN) illustrated in FIG. 10 may be a master BS connected to the UE. The MN may have a key K_{MN} for secure communication with the UE.

A source-secondary node (S-SN) illustrated in FIG. 10 may be a secondary BS connected to the UE for dual connectivity. The S-SN may have a key K_{SN} for secure communication with the UE.

The target-secondary nodes (T-SNs) illustrated in FIG. 10 may be candidate secondary BSs to be connected to the UE on behalf of the S-SN for dual connectivity. The T-SN may acquire the key K_{SN} for secure communication with the UE through the procedure described below.

The procedure of FIG. 10 is disclosed based on the procedure of FIG. 9. In other words, the majority of the procedure in FIG. 10 corresponds to the procedure illustrated in FIG. 9. Accordingly, for readability, the content already illustrated in FIG. 9 may not be described in the content of FIG. 10.

Hereinafter, individual description for operations to be performed is made. Hereinafter, it is disclosed as if respective operations are sequentially performed, but the order of the operations may be changed if it works even though the order of the operations is changed.

In operation 1, the MN may perform one or more of the following processes.
The MN may select an SN counter value. A plurality of SN counter values may be applied per T-SN.
The MN may generate K_{SN} to be transferred to the T-SN. Each K_{SN} may be generated using a value of one of the selected SN counters.

In operation 2, the MN may perform one or more of the following processes.
The MN may perform a procedure corresponding to operation 2 in FIG. 9 to the T-SN.

In operation 3, the T-SNs may perform one or more of the following processes.
Each T-SN may perform a procedure corresponding to operation 4 in FIG. 9 to the MN.

In operation 4, the MN may perform one or more of the following processes.
The MN may provide a list of the selected T-SNs to the UE.
The MN may provide condition information indicating when each T-SN can be selected to the UE. The information may be included as a portion of the conditional PSCell change (CPC) configuration.
The MN may provide SN counter values corresponding to K_{SN} allocated to each T-SN to the UE. Thereafter, the UE may determine which T-SN has the generated K_{SN} and which SN counter value is used to generate K_{SN} through the information.

In operation 5, the UE may inform the MN that the task has been completed.

In operation 5a, the MN may inform the S-SN of the process situation of the task. For example, the MN may inform the S-SN that the UE has received the CPC configuration.

In operation 6, the UE may perform one or more of the following processes.
The UE may select a T-SN to replace the S-SN, based on the information received in operation 4. For example, the UE may select a replaceable T-SN from among the received T-SN list, based on the received condition information (for example, CPC configuration).
The UE may generate a key K_{SN} to be used for secure communication with the selected T-SN by using K_{MN} possessed by the UE itself and the SN counter values associated with the selected T-SN received in operation 4.

In operation 7, the UE may inform the MN that the task has been completed. At this time, one or more of the following processes may be performed.
The UE may transmit information that may refer to a T-SN to be connected to the UE itself to the MN.
The UE may transmit information (being marked as KI in the drawing) that refers to the SN counter value selected by the UE itself in operation 6 to the MN. The information may be the SN counter value selected by the UE itself in operation 6. The information may be third information that may specific the SN counter value selected by the UE itself in operation 6. If it can be determined which SN counter value has been selected without transmission of the information, the transmission of the information may be omitted.

In operation 8, the MN may make a request for releasing the connection to the S-SN.

In operation 9, the S-SN may inform the MN that the connection has been released.

In operation 10, the MN may inform the T-SN to be connected to the UE that the task has been completed. At this time, one or more of the following processes may be performed.
The MN may transmit information that refers to K_{MN} corresponding to the SN counter value selected by the UE in operation 6 to the T-SN. If it can be determined which SN counter value has been selected without transmission of the information, the transmission of the information may be omitted.

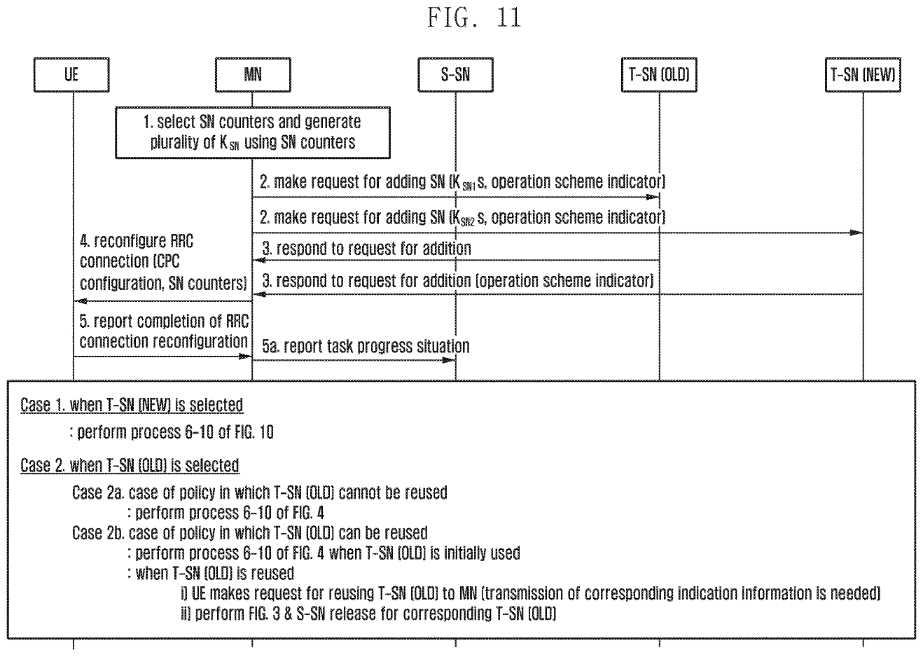

FIG. 11 is a diagram illustrating a procedure of continuously changing a secondary node in dual connectivity by linking the two methods illustrated in FIGS. 3 and 9.

A master node (MN) illustrated in FIG. 11 may be a master BS connected to the UE. The MN may have a key K_{MN} for secure communication with the UE.

A source-secondary node (S-SN) illustrated in FIG. 11 may be a secondary BS connected to the UE for dual connectivity. The S-SN may have a key K_{SN} for secure communication with the UE.

The target-secondary nodes (T-SNs) illustrated in FIG. 11 may be candidate secondary BSs to be connected to the UE on behalf of the S-SN for dual connectivity. The T-SN may acquire the key K_{SN} for secure communication with the UE through the procedure described below. At this time, the T-SN (OLD) may mean the SN operating in the manner illustrated in FIG. 3. At this time, a T-SN (NEW) may mean the SN operating in the manner illustrated in FIG. 9. The T-SN (OLD) may mean the SN that does not support a selective SCG function described below, the T-SN (NEW) may mean the SN that supports the selective SCG function described below.

The procedure of FIG. 11 is disclosed based on the procedures of FIGS. 3 and 9. In other words, the majority of the procedure in FIG. 11 corresponds to the procedure illustrated in FIGS. 3 and 9. Accordingly, for readability, the content already illustrated in FIGS. 3 and 9 may not be described in the content of FIG. 11.

Hereinafter, individual description for operations to be performed is made. Hereinafter, it is disclosed as if respective operations are sequentially performed, but the order of the operations may be changed if it works even though the order of the operations is changed.

In operation 1, the MN may perform one or more of the following processes.
The MN may select an SN counter value. A plurality of SN counter values may be applied per T-T-SN.
The MN may generate K_{SN} to be transferred to the T-SN. Each K_{SN} may be generated using a value of one of the selected SN counters.

In operation 2, the MN may perform one or more of the following processes.
The MN may perform a procedure corresponding to operation 1 in FIG. 9 to the T-SN.
The MN may send an indicator asking each T-SN how it operates. In other words, an indicator asking about whether the corresponding T-SN operates in the scheme illustrated in FIG. 3 or the scheme illustrated in FIG. 9. This may be interpreted to be the same as transmitting an indicator asking about whether the corresponding T-SN supports the selective SCG function. Such indicators may be information on the operation scheme of each T-SN or information itself on whether the selective SCG function is supported.

In operation 3, the T-SNs may perform one or more of the following processes.
Each T-SN may perform a procedure corresponding to operation 4 in FIG. 3 or operation 4 in FIG. 9 to the MN.
When the corresponding T-SN is the SN operating in the scheme illustrated in FIG. 3, the T-SN may store only one of the K_{SN} values (for example, the first of the received K_{SN} values) received in operation 2.
When the corresponding T-SN is the SN operating in the scheme illustrated in FIG. 9, the T-SN may store all of the K_{SN} values received in operation 2. Further, when the corresponding T-SN is the SN operating in the scheme illustrated in FIG. 9, the T-SN may transmit an indicator indicating that the T-SN itself is the SN operating in the scheme illustrated in FIG. 9.

In operation 4, the MN may perform one or more of the following processes.
The MN may provide a list of the selected T-SNs to the UE.
The MN may provide condition information indicating when each T-SN can be selected to the UE. The information may be included as a portion of the conditional PSCell change (CPC) configuration.
The MN may provide the SN counter value(s) corresponding to K_{SN}(s) allocated to each T-SN to the UE. Thereafter, the UE may determine which T-SN has the generated K_{SN}(s) and which SN counter value(s) is used to generate K_{SN}(s) through the information.
The MN may inform the UE of a function supported by each T-SN. For example, the ME may inform the UE whether each T-SN is the SN operating in the scheme illustrated in FIG. 3 or the SN operating in the scheme illustrated in FIG. 9. This may be interpreted to be the same as informing whether or not the corresponding T-SN is the SN supporting the selective SCG function. The information may be included as a portion of the conditional PSCell change (CPC) configuration.
The MN may provide policy information containing whether the SN operating in the scheme illustrated in FIG. 3 can be reused to the UE. A more detailed description thereof will be referred to FIG. 7. The information may be included as a portion of the conditional PSCell change (CPC) configuration.

In operation 5, the UE may inform the MN that the task has been completed.

In operation 5a, the MN may inform the S-SN of the process situation of the task. For example, the MN may inform the S-SN that the UE has received the CPC configuration.

Thereafter, a process of making the selective SCG is described.

### CASE1. Selected T-SN BASED on FIG. 9

Operations 6 to 10 in FIG. 6 may be performed.
When one T-SN is selected several times, the UE may select an SN counter value associated with the corresponding T-SN possessed by the UE itself in a specific order. For example, the UE may select the smallest value among the SN counter values associated with the corresponding T-SN which the UE itself currently possesses. The used SN counter value may be discarded after being used.
When one T-SN is selected several times, the T-SN may select K_{SN} which the T-SN itself possesses in a specific order. For example, the T-SN may select K_{SN} associated with an SN counter corresponding to the smallest value which the UE currently stores in connection with the T-SN. The used K_{SN} value may be discarded when the connection with the UE is released.

### CASE2. Selected T-SN BASED on FIG. 3 & Non-Reuse Policy

The corresponding T-SN can be selected only once in which case operations 6 to 10 illustrated in FIG. 4 may be performed.

### CASE3. Selected T-SN Based on FIG. 3 & Reuse Policy

When the corresponding T-SN is initially selected, operations 6 to 10 illustrated in FIG. 4 may be performed.
When the corresponding T-SN is reselected, the following process may be performed. The UE may make a request for the connection with the corresponding T-SN to the MN. At this time, the UE may transmit a series of information required for allowing the MN to recognize that “the corresponding T-SN operates based on FIG. 3 and is reselected”. For example, the UE may additionally transmit information on “the fact that the corresponding T-SN operates based on FIG. 3” and/or “the fact that the corresponding T-SN was reselected” to the MN. When the MN already knew the information, the transmission of the information may be omitted. Further, one of the following processes may be additionally performed.
Operations 1 to 8 in FIG. 3 may be performed.
A procedure (operations 8 to 9 in FIG. 4) of releasing the S-SN may be performed.

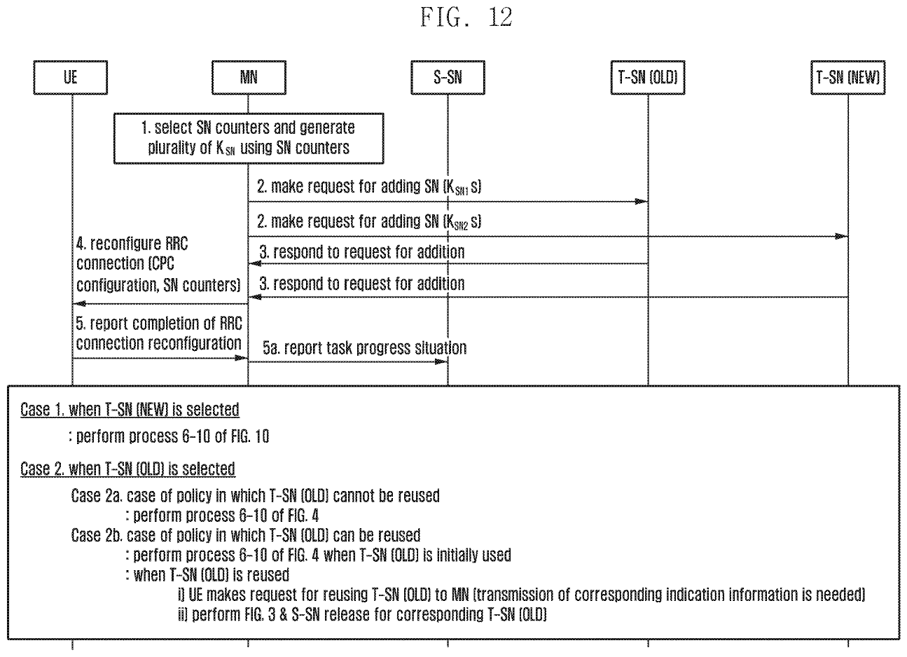

FIG. 12 is a diagram illustrating another procedure of continuously changing a secondary node in dual connectivity by linking the two methods illustrated in FIGS. 3 and 9.

A master node (MN) illustrated in FIG. 12 may be a master BS connected to the UE. The MN may have a key K_{MN} for secure communication with the UE.

A source-secondary node (S-SN) illustrated in FIG. 12 may be a secondary BS connected to the UE for dual connectivity. The S-SN may have a key K_{SN} for secure communication with the UE.

The target-secondary nodes (T-SNs) illustrated in FIG. 12 may be candidate secondary BSs to be connected to the UE on behalf of the S-SN for dual connectivity. The T-SN may acquire the key K_{SN} for secure communication with the UE through the procedure described below. At this time, the T-SN (OLD) may mean the SN operating in the manner illustrated in FIG. 3. At this time, a T-SN (NEW) may mean the SN operating in the manner illustrated in FIG. 9. The T-SN (OLD) may mean the SN that does not support a selective SCG function described below, the T-SN (NEW) may mean the SN that supports the selective SCG function described below.

The procedure of FIG. 12 is disclosed based on the procedures of FIGS. 3 and 9. In other words, the majority of the procedure in FIG. 12 corresponds to the procedure illustrated in FIGS. 3 and 9. Accordingly, for readability, the content already illustrated in FIGS. 3 and 9 may not be described in the content of FIG. 12.

Hereinafter, individual description for operations to be performed is made. Hereinafter, it is disclosed as if respective operations are sequentially performed, but the order of the operations may be changed if it works even though the order of the operations is changed.

In operation 1, the MN may perform one or more of the following processes.
The MN may select SN counter values for T-SNs (OLD). The number of SN counter values prepared for the T-SNs (OLD) may be singular.
The MN may select SN counter values for T-SNs (NEW). The number of SN counter values prepared for the T-SNs (NEW) may be singular.
The MN may generate K_{SN} to be transferred to each T-SN (OLD). K_{SN} may be generated using K_{MN} and the SN counter value allocated to the corresponding T-SN (OLD).
The MN may generate K_{SN} to be transferred to each T-SN (NEW). K_{SN} may be generated using K_{MN} and one of the SN counter values allocated to the corresponding T-SN (NEW).

In operation 2, the MN may perform one or more of the following processes.
The MN may perform a procedure corresponding to operation 2 in FIG. 3 to each T-SN (OLD).
The MN may perform a procedure corresponding to operation 1 in FIG. 9 each T-SN (NEW).

In operation 3, the T-SNs may perform one or more of the following processes.
Each T-SN may perform a procedure corresponding to operation 4 in FIG. 3 or operation 4 in FIG. 9 to the MN.

In operation 4, the MN may perform one or more of the following processes.
The MN may provide a list of the selected T-SNs to the UE.
The MN may provide condition information indicating when each T-SN can be selected to the UE. The information may be included as a portion of the conditional PSCell change (CPC) configuration.
The MN may provide the SN counter value(s) corresponding to K_{SN}(s) allocated to each T-SN to the UE. Thereafter, the UE may determine which T-SN has the generated K_{SN}(s) and which SN counter value(s) is used to generate K_{SN}(s) through the information.
The MN may inform the UE of a function supported by each T-SN. For example, the ME may inform the UE whether each T-SN is the SN operating in the scheme illustrated in FIG. 3 or the SN operating in the scheme illustrated in FIG. 9. This may be interpreted to be the same as informing whether or not the corresponding T-SN is the SN supporting the selective SCG function. The information may be included as a portion of the conditional PSCell change (CPC) configuration.
The MN may provide policy information containing whether the SN operating in the scheme illustrated in FIG. 3 can be reused to the UE. A more detailed description thereof will be referred to FIG. 7.

In operation 5, the UE may inform the MN that the task has been completed.

In operation 5a, the MN may inform the S-SN of the process situation of the task. For example, the MN may inform the S-SN that the UE has received the CPC configuration.

Thereafter, a process of making the selective SCG is described.

### CASE1. Selected T-SN Based on FIG. 9

Operations 6 to 10 in FIG. 10 may be performed.
When one T-SN is selected several times, the UE may select an SN counter value associated with the corresponding T-SN possessed by the UE itself in a specific order. For example, the UE may select the smallest value among the SN counter values associated with the corresponding T-SN which the UE itself currently possesses. The used SN counter value may be discarded after being used.
When one T-SN is selected several times, the T-SN may select K_{SN} which the T-SN itself possesses in a specific order. For example, the T-SN may select K_{SN} associated with an SN counter corresponding to the smallest value which the UE currently stores in connection with the T-SN. The used K_{SN} value may be discarded when the connection with the UE is released.

### CASE2. Selected T-SN Based on FIG. 3 & Non-Reuse Policy

The corresponding T-SN can be selected only once in which case operations 6 to 10 illustrated in FIG. 4 may be performed.

### CASE3. Selected T-SN Based on FIG. 3 & Reuse Policy

When the corresponding T-SN is initially selected, operations 6 to 10 illustrated in FIG. 4 may be performed.
When the corresponding T-SN is reselected, the following process may be performed. The UE may make a request for the connection with the corresponding T-SN to the MN. At this time, the UE may notify of a series of necessary information so that the MN can recognize that “the corresponding T-SN operates based on FIG. 3 and has been reselected.” For example, the UE may additionally notify the MN of “the fact that the corresponding T-SN operates based on FIG. 3” and/or “the fact that the corresponding T-SN has been reselected”. If the MN already knew the information, the notification may be omitted. Further, one of the following processes may be additionally performed.
Operations 1 to 8 in FIG. 3 may be performed.
A procedure (operations 8 to 9 in FIG. 4) of releasing the S-SN may be performed.

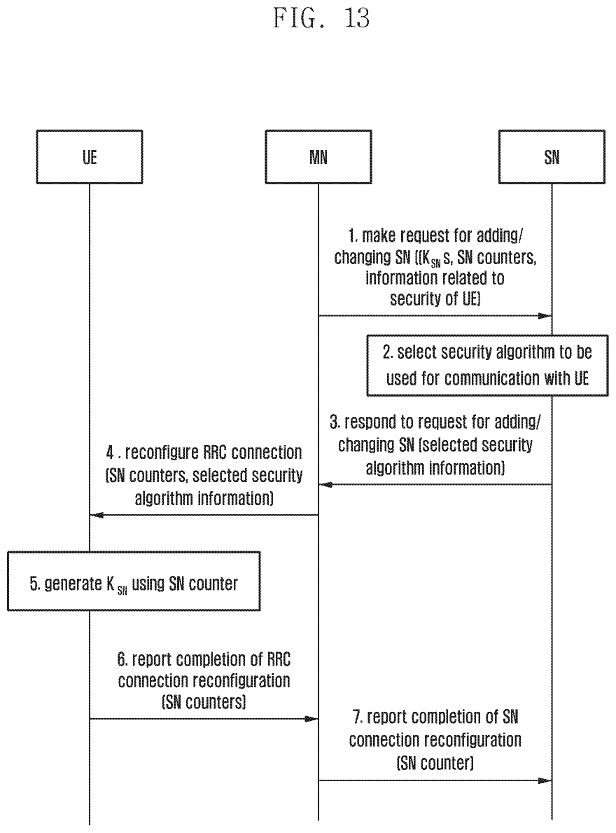

FIG. 13 is a diagram illustrating another method of managing keys in dual connectivity according to an embodiment of the disclosure.

A master node (MN) illustrated in FIG. 13 may be a master BS connected to the UE. The MN may have an encryption key (abbreviated as a security key or a key) K_{MN} for secure communication with the UE.

A secondary node (SN) illustrated in FIG. 13 may be a secondary BS connected to the UE for dual connectivity. The SN may acquire a key K_{SN} for secure communication with the UE through the procedure described below.

Hereinafter, individual description for operations to be performed for key management according to FIG. 13 is provided. Hereinafter, it is disclosed as if respective operations are sequentially performed, but the order of the operations may be changed if it works even though the order of the operations is changed.

In operation 1, the MN may perform one or more of the following operations.
The MN may select an SN counter value. For example, the MN may generate the SN counter value and select the SN counter value. The SN counter is a constant and may be a value associated with a key K_{SN} to be transferred to the SN described below.
The MN may generate K_{SN} to be transferred to the SN. Each K_{SN} may be generated using K_{MN} and one of the selected SN counter values. For example, K_{SN} may be a key value generated through the output with K_{MN} and one of the selected SN counter values as the input of a key derivation function (KDF).
The MN may transmit the generated K_{SN} to the SN.
The MN may transmit the generated SN counter values to the SN. The transmission of the information may be omitted.
The MN may transmit information related to security of the UE to the SN. For example, the MN may transmit the type of security algorithms available by the UE to the SN. In another example, the MN may transmit a policy related to a security method to be used by the UE to the SN.

In operation 2, the SN may perform one or more of the following processes.
The SN may select a security algorithm to be used in secure communication with the UE.
The SN may induce security keys to be used with the UE from K_{SN} received from the MN. At this time, during the induction process, security keys corresponding to the selected security algorithm may be induced.
The SN may select a security method to be used with the UE, based on the security policy received from the MN in operation 1.

In operation 3, the SN may perform one or more of the following processes.
The SN may transmit information on the security algorithm selected by the SN itself to the MN.
The SN may transmit the security method used by the SN itself to the MN.

In operation 4, the MN may perform one or more of the following processes.
The MN may transmit the SN counter values selected in operation 1.
The MN may transmit information related to the security algorithm or security method received from the SN in operation 3 to the UE.

In operation 5, the UE may perform one or more of the following processes.
The UE may select one of the SN counter values received from the MN.
The UE may generate K_{SN} by using K_{MN} possessed by the UE itself and the selected SN counter value.
The UE may induce security keys to be used with the SN from the generated K_{SN}. During the induction process, the UE may induce security keys corresponding to the security algorithm received in operation 4.

In operation 6, the UE may inform the MN that the task has been completed. At this time, one of the following processes may be performed.
The UE may transmit the SN counter value selected by the UE itself in operation 5 to the MN. The transmission of the information may be omitted.

In operation 7, the MN may inform the SN that the task has been completed. At this time, one of the following processes may be performed.
The MN may transmit the SN counter values received from the UE in operation 6 to the SN. The transmission of the information may be omitted.

[Error processing method] According to the above description, in operation 1, operation 6, and operation 7, the SN counter values may be transmitted or, alternatively, the transmission may be omitted. When the information is transmitted, the transmitted information may be used for handling an error situation.

### [Case A]

The SN may identify the SN counters received from the MN in operation 7 and select K_{SN} values corresponding thereto.
Through the method, it is possible to reduce the possibility of errors in which the UE and the SN select different K_{SN} values.

### [Case B]

The SN may select a K_{SN} value without identifying the SN counters received from the MN in operation 7.
In the above case, the UE and the SN may have to select K_{SN} values to be used according to a predetermined order. For example, the UE may sequentially select SN counter values according to the order of reception and use the K_{SN} values induced therefrom, and the SN may also sequentially select and use K_{SN} values according to the order of reception.
In the above case, the possibility of errors in which the UE and the SN select difference K_{SN} values increases.
When the error occurs, the SN may identify the SN counters received in operation 7 and reselect K_{SN} values corresponding thereto. Through the method, the SN may modify the occurring error.

The error processing method may be included as a portion of operation 7 and performed.

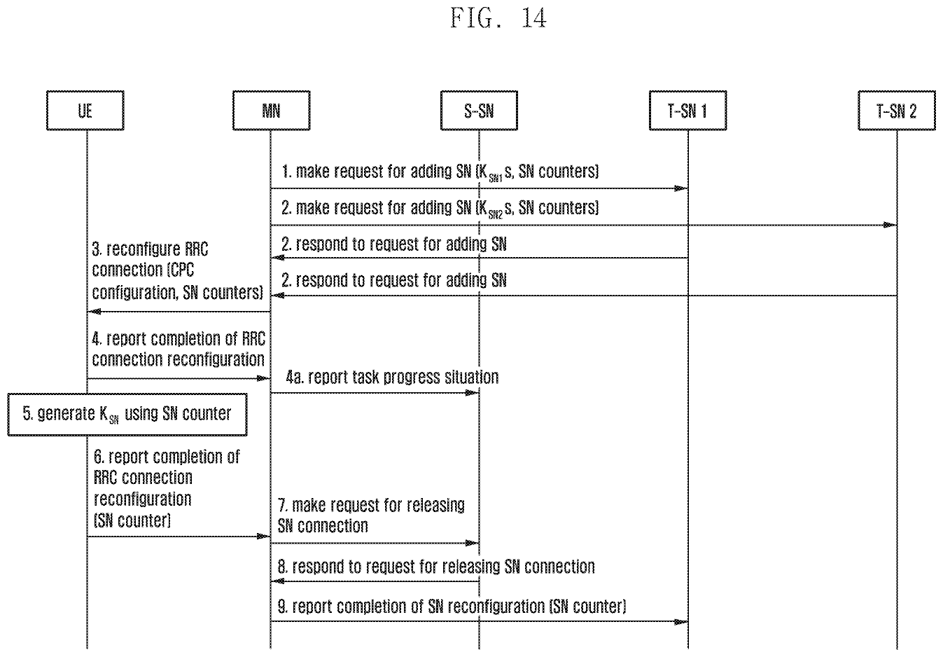

FIG. 14 is a diagram illustrating a procedure of changing a secondary node in dual connectivity, based on the method illustrated in FIG. 13.

A master node (MN) illustrated in FIG. 14 may be a master BS connected to the UE. The MN may have a key K_{MN} for secure communication with the UE.

A source-secondary node (S-SN) illustrated in FIG. 14 may be a secondary BS connected to the UE for dual connectivity. The S-SN may have a key K_{SN} for secure communication with the UE.

The target-secondary nodes (T-SNs) illustrated in FIG. 14 may be candidate secondary BSs to be connected to the UE on behalf of the S-SN for dual connectivity. The T-SN may acquire the key K_{SN} for secure communication with the UE through the procedure described below.

The procedure of FIG. 14 is disclosed based on the procedure of FIG. 13. In other words, the majority of the procedure in FIG. 14 corresponds to the procedure illustrated in FIG. 13. Accordingly, for readability, the content already illustrated in FIG. 13 may not be described in the content of FIG. 14.

Hereinafter, individual description for operations to be performed is made. Hereinafter, it is disclosed as if respective operations are sequentially performed, but the order of the operations may be changed if it works even though the order of the operations is changed.

In operation 1, the MN may perform one or more of the following processes.
The MN may select an SN counter value. A plurality of SN counter values may be applied per T-SN.
The MN may generate K_{SN} to be transferred to the T-SN. Each K_{SN} may be generated using K_{MN} and a value of one of the selected SN counters.
The MN may transmit the generated K_{SN} to each T-SN.
The MN may transmit the generated SN counter values to each T-SN. The transmission of the information may be omitted.
The MN may transmit security-related information to each T-SN. A detailed description of the security-related information may be referred to operation 1 in FIG. 13.

In operation 2, the T-SNs may perform one or more of the following processes.
Each T-SN may perform a procedure corresponding to operations 2 to 3 in FIG. 13.

In operation 3, the MN may perform one or more of the following processes.
The MN may provide a list of the selected T-SNs to the UE.
The MN may provide condition information indicating when each T-SN can be selected to the UE. The information may be included as a portion of the conditional PSCell change (CPC) configuration.
The MN may provide SN counter values “corresponding to K_{SN} allocated to each T-SN” to the UE. Thereafter, the UE may determine which T-SN has “the generated K_{SN} and which SN counter value is used to generate K_{SN} ” through the information.

In operation 4, the UE may inform the MN that the task has been completed.

In operation 4a, the MN may inform the S-SN of the process situation of the task. For example, the MN may inform the S-SN that the UE has received the CPC configuration.

In operation 5, the UE may perform one or more of the following processes.
The UE may select a T-SN to replace the S-SN, based on the information received from the MN in operation 3. For example, the UE may select a replaceable T-SN from among the received T-SN list, based on the received condition information (for example, CPC configuration).
The UE may generate a key K_{SN} to be used for secure communication with the selected T-SN by using K_{MN} possessed by the UE itself and “one of the SN counter values associated with the selected T-SN” received in operation 3.

In operation 6, the UE may inform the MN that the task has been completed. At this time, one or more of the following processes may be performed.
The UE may transmit information that may refer to a T-SN to be connected to the UE itself to the MN.
The UE may transmit the SN counter value selected by the UE itself in operation 5 to the MN. The transmission of the information may be omitted.

In operation 7, the MN may make a request for releasing the connection to the S-SN.

In operation 8, the S-SN may inform the MN that the connection has been released.

In operation 9, the MN may inform the T-SN to be connected to the UE that the task has been completed. At this time, one or more of the following processes may be performed.
The MN may transmit “the SN counter values received in operation 6” to the T-SN. The transmission of the information may be omitted.

### [Error PROCESSING METHOD]

Through the above-described operations, the UE and the T-SN may be able to perform secure communication. However, when K_{SN} values selected by the UE and the T-SN do not match for some reason, normal secure communication may not be possible. An error processing method for the above case will be referred to the [Error processing] method illustrated in FIG. 13. That is, K_{SN} may be identified or reselected through the SN counter values.
The error processing method may be included as a portion of operation 9 and performed.

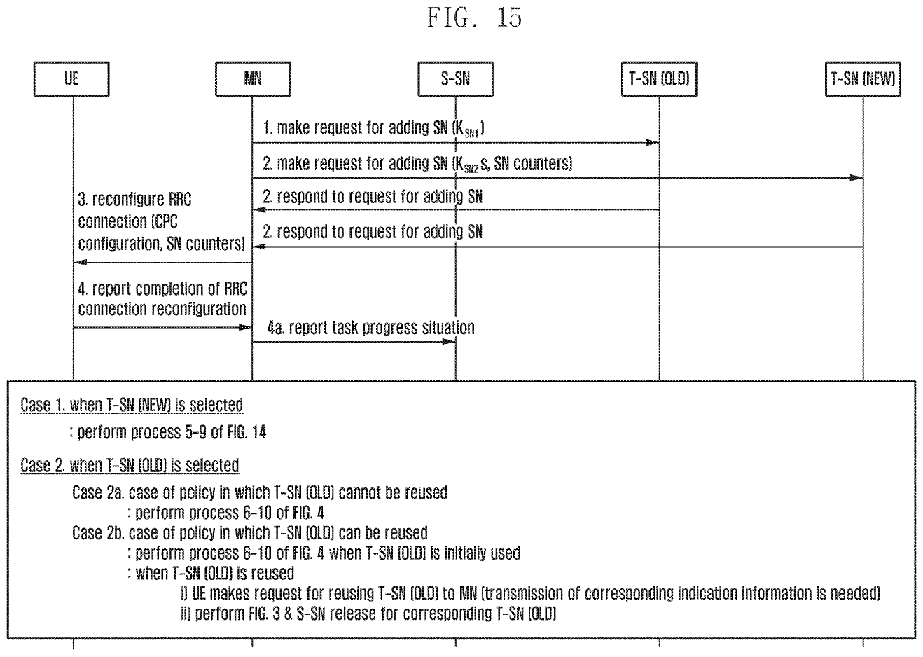

FIG. 15 is a diagram illustrating another procedure of continuously changing a secondary node in dual connectivity by linking the two methods illustrated in FIG. 3 (and FIG. 4) and FIG. 13 (and FIG. 14).

A master node (MN) illustrated in FIG. 15 may be a master BS connected to the UE. The MN may have a key K_{MN} for secure communication with the UE.

A source-secondary node (S-SN) illustrated in FIG. 15 may be a secondary BS connected to the UE for dual connectivity. The S-SN may have a key K_{SN} for secure communication with the UE.

The target-secondary nodes (T-SNs) illustrated in FIG. 15 may be candidate secondary BSs to be connected to the UE on behalf of the S-SN for dual connectivity. The T-SN may acquire the key K_{SN} for secure communication with the UE through the procedure described below. At this time, the T-SN (OLD) may be an SN operating in the scheme illustrated in FIG. 3 (and FIG. 4). The T-SN (NEW) may be an SN operating in the scheme illustrated in FIG. 13 (and FIG. 14). The T-SN (OLD) may mean the SN that does not support a selective SCG function described below, the T-SN (NEW) may mean the SN that supports the selective SCG function described below.

The procedure of FIG. 15 is illustrated based on the procedure of FIG. 3 (and FIG. 4) and FIG. 13 (and FIG. 14). In other words, the majority of the procedure in FIG. 15 corresponds to the procedure illustrated in FIG. 3 (and FIG. 4) and FIG. 13 (and FIG. 14). Accordingly, for readability, the content already illustrated in FIG. 3 (and FIG. 4) and FIG. 13 (and FIG. 14) may not be described in the content of FIG. 15.

Hereinafter, individual description for operations to be performed according to the procedure of FIG. 15 is provided. Hereinafter, it is disclosed as if respective operations are sequentially performed, but the order of the operations may be changed if it works even though the order of the operations is changed.

In operation 1, the MN may perform one or more of the following processes.

### [For T-SN(OLD)]

(Operation O) The MN may perform the process of operations 1 to 2 illustrated in FIG. 3 for each T-SN (OLD). In other words, the MN may select an SN counter value for each T-SN (OLD), generate a K_{SN} value to be transferred to the T-SN (OLD), based on the selected SN counter value, and transfer the generated K_{SN} values to the T-SN (OLD).
If the MN knows in advance that a specific T-SN is an OLD version, the MN may immediately perform “operation O” for the corresponding T-SN.
If the MN does not know in advance that the specific T-SN (OLD) is the OLD version, one or more of the following processes may be performed.
The MN may perform “operation O” after first identifying the version of the T-SN. For example, the MN may identify the version of the T-SN by communicating with the T-SN. In another example, the MN may identify the version of the T-SN by obtaining information from the outside without direct communication with the T-SN.
The MN may perform “operation O”, based on the assumption that the version of the T-SN is OLD. In the future, the MN may identify that no additional operation is required after identifying the version of the T-SN. The MN may identify the version of the T-SM by performing direct communication with the T-SN or obtaining information from the outside without direct communication with the T-SN.
The MN may perform operation 1 of FIG. 13, based on the assumption that the version of the T-SN is NEW. In this case, since the T-SN does not support the input received through operation 1 of FIG. 13, the T-SN may response to the input through a rejection message. In the above case, the MN may identify that the version of the T-SN is OLD and, accordingly, perform “operation O”.

### [For T-SN(NEW)]

(Operation N) The MN may perform the process of operation 1 illustrated in FIG. 13 for each T-SN (NEW). In other words, the MN may select SN counter values for each T-SN (NEW). Further, the MN may generate K_{SN} values to be transferred to the T-SN (NEW), based on the selected SN counter values. The MN may transfer the generated K_{SN} values to the T-SN (NEW). The MN may transfer the selected SN counter values to the T-SN (NEW) but transmission of the information may be omitted.
If the MN knows in advance that a specific T-SN is a NEW version, the MN may immediately perform “operation N” for the corresponding T-SN.
When the MN does not know in advance that the specific T-SN (NEW) is the NEW version, one or more of the following processes may be performed.
The MN may perform “operation N” after identifying the version of the T-SN. For example, the MN may identify the version of the T-SN by communicating with the T-SN. In another example, the MN may identify the version of the T-SN by obtaining information from the outside without direct communication with the T-SN.
The MN may perform “operation O”, based on the assumption that the version of the T-SN is OLD. In the future, the MN may identify that an additional operation is required after identifying the version of the T-SN. The MN may identify the version of the T-SN by performing direct communication with the T-SN or obtaining information from the outside without direct communication with the T-SN. “Operation N” may be performed after the MN identifies that the additional operation required for the T-SN. At this time, when the reuse of transmission information of “operation O” which has been already performed is smooth, some operations of “operation N” may be omitted according thereto. Since the MN has already transmitted one K_{SN} value to the T-SN in “operation O”, the MN may transmit only the remaining values except for the transmitted value in “operation N”.
The MN may perform “operation N”, based on the assumption that the version of the T-SN is NEW. In the future, the MN may identify that no additional operation is required after identifying the version of the T-SN. (The MN may identify the version of the T-SM by performing direct communication with the T-SN or obtaining information from the outside without direct communication with the T-SN. Alternatively, when “operation N” is performed, the version of the T-SN may be identified from the fact that the T-SN has not transmitted a rejection message.) In operation 2, the T-SNs may perform one or more of the following processes.
T-SN(s) of the OLD version may perform operations 3 to 4 in FIG. 3.
T-SN(s) of the NEW version may perform operations 2 to 3 in FIG. 13.

In operation 3, the MN may perform one or more of the following processes.
The MN may provide a list of the selected T-SNs to the UE.
The MN may provide condition information indicating when each T-SN can be selected to the UE. The information may be included as a portion of the conditional PSCell change (CPC) configuration.
The MN may provide “SN counter value(s) corresponding to K_{SN}(s) allocated to each T-SN” to the UE. In the future, the UE may determine which T-SN has the generated K_{SN}(s) and which SN counter value(s) is used to generate K_{SN}(s) through the information.
The MN may inform the UE of a function supported by each T-SN. For example, the MN may inform the UE whether each T-SN is the SN operating in the scheme illustrated in FIG. 3 or the SN operating in the scheme illustrated in FIG. 13. (The information may be transmitted in various methods. For example, through the number of SN counter(s) allocated to a specific T-SN, the operation scheme of the corresponding T-SN may be notified. That is, the T-SN may be the SN operating in the scheme illustrated in FIG. 3 when the number of SN counter values allocated to the specific T-SN is 1, and the T-SN may be the SN operating in the scheme illustrated in FIG. 13 when the number of SN counter values allocated to the specific T-SN is plural.

However, this is only an example, and the method by which the MN notifies of the operation scheme of each T-SN is not limited to the example. This may be interpreted to be the same as informing whether or not the corresponding T-SN is the SN supporting the selective SCG function. The information may be included as a portion of the conditional PSCell change (CPC) configuration.
The MN may provide policy information containing whether the SN operating in the scheme illustrated in FIG. 3 can be reused to the UE. A more detailed description thereof will be referred to FIG. 7.

In operation 4, the UE may inform the MN that the task has been completed.

In operation 4a, the MN may inform the S-SN of the process situation of the task. For example, the MN may inform the S-SN that the UE has received the CPC configuration.

Thereafter, a process of making the selective SCG is described.

### CASE1. Selected T-SN Based on FIG. 13 (that is, T-SN Being NEW Version)

Operations 5 to 9 in FIG. 14 may be performed.

### CASE2. Selected T-SN BASED on FIG. 3 & (that is, T-SN Being Old Version) & Non-Reuse Policy

The corresponding T-SN can be selected only once in which case operations 6 to 10 illustrated in FIG. 4 may be performed.

### CASE3. Selected T-SN Based on FIG. 3 (that is, T-SN BEING Old Version) & Reuse Policy

When the corresponding T-SN is initially selected, operations 6 to 10 illustrated in FIG. 4 may be performed.
When the corresponding T-SN is reselected, the following process may be performed. The UE may make a request for the connection with the corresponding T-SN to the MN. At this time, the UE may notify of a series of necessary information so that the MN can recognize that “the corresponding T-SN operates based on FIG. 3 and has been reselected”. For example, the UE may additionally notify the MN of “the fact that the corresponding T-SN operates based on FIG. 3” and/or “the fact that the corresponding T-SN has been reselected”. If the MN already knew the information, the notification may be omitted. Further, one of the following processes may be additionally performed.
Operations 1 to 8 in FIG. 3 may be performed.

A procedure (operations 8 to 9 in FIG. 4) of releasing the S-SN may be performed. It should be noted that the above-described configuration diagrams, illustrative diagrams of control/data signal transmission methods, illustrative diagrams of operation procedures, and structural diagrams as illustrated in FIG. 1A to FIG. 15 are not intended to limit the scope of protection of the disclosure. That is, all the constituent elements, entities, or operation steps shown and described in FIG. 1A to FIG. 15 should not be construed as being essential elements for the implementation of the disclosure, and even when including only some of the elements, the disclosure may be implemented without impairing the true of the disclosure.

The above-described operations of the embodiments may be implemented by providing any unit of a device with a memory device storing corresponding program codes. That is, a controller in the device may perform the above-described operations by reading and executing the program codes stored in the memory device by means of a processor or central processing unit (CPU).

Various units or modules of an entity or terminal device set forth herein may be operated using hardware circuits such as complementary metal oxide semiconductor-based logic circuits, firmware, or hardware circuits such as combinations of software and/or hardware and firmware and/or software embedded in a machine-readable medium. For example, various electrical structures and methods may be implemented using transistors, logic gates, and electrical circuits such as application-specific integrated circuits.

Methods disclosed in the claims or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

1. A method of operating a master node (MN) connected to a user equipment (UE) in a wireless communication system, the method comprising:
selecting a first secondary node (SN) counter value for a first target SN not supporting a selective secondary cell group (SCG) function;
generating a first key value for secure communication between the UE and the first target SN based on the first SN counter value;
transmitting, to the first target SN, the first key value corresponding to the first target SN;
selecting a plurality of second SN counter values for a second target SN supporting the selective SCG function;
generating a plurality of second key values for secure communication between the UE and the second target SN based on the plurality of second SN counter values;
transmitting, to the second target SN, the plurality of second key values corresponding to the second target SN; and
transmitting conditional PSCell change (CPC) configuration information, the first SN counter value, and the plurality of second SN counter values to the UE.

2. The method of claim 1, further comprising:
receiving, from the first target SN, information on whether the first target SN supports the selective SCG function; and
receiving, from the second target SN, information on whether the second target SN supports the selective SCG function.

3. The method of claim 1, wherein the CPC configuration information comprises information on whether the first target SN or the second target SN supports the selective SCG function.

4. The method of claim 1, further comprising receiving, from the first target SN or the second target SN, a rejection message for a key value received by the first target SN or the second target SN or a request message for an additional key value.

5. The method of claim 1, further comprising transmitting, to the UE, information on whether the first target SN not supporting the selective SCG function can be reused.

6. The method of claim 5, further comprising:
in case that the first target SN can be reused, receiving a request for reuse of the first target SN from the UE;
selecting a third SN counter value for the first target SN and generating a third key value, based on the third SN counter value;
transmitting the third key value to the first target SN; and
transmitting, to the UE, the third SN counter value corresponding to the third key value.

7. A method of operating a user equipment (UE) in a wireless communication system, the method comprising:
receiving, from a master node (MN) connected to the UE, conditional PSCell change (CPC) configuration information, a first SN counter value corresponding to a first key value transferred to a first target secondary node (SN) not supporting a selective secondary cell group (SCG) function, and a plurality of second SN counters corresponding to a plurality of second key values transmitted to a second target SN supporting the selective SCG function;
generating a first key value or a second key value based on at least one of the first SN counter value or the plurality of second SN counter values; and
performing an SN change to the first target SN through the first key value or an SN change to the second target SN through the second key value.

8. The method of claim 7,
wherein the CPC configuration information comprises information on whether the first target SN or the second target SN supports the selective SCG function, and
wherein the change to the second target SN can be performed several times using the plurality of second key values generated based on the CPC configuration information.

9. A master node (MN) operatively connected to a user equipment (UE) in a wireless communication system, the MN comprising:
a communication unit; and
a controller,
wherein the controller is configured to:
select a first secondary node (SN) counter value for a first target SN not supporting a selective secondary cell group (SCG) function,
generate a first key value for secure communication between the UE and the first target SN based on the first SN counter value,
transmit, to the first target SN, the first key value corresponding to the first target SN,
select a plurality of second SN counter values for a second target SN supporting the selective SCG function,
generate a plurality of second key values for secure communication between the UE and the second target SN based on the plurality of second SN counter values,
transmit, to the second target SN, the plurality of second key values corresponding to the second target SN, and
transmit conditional PSCell change (CPC) configuration information, the first SN counter value, and the plurality of second SN counter values to the UE.

10. The MN of claim 9, wherein the controller is further configured to:
receive, from the first target SN information on whether the first target SN supports the selective SCG function; and
receive, from the second target SN, information on whether the second target SN supports the selective SCG function.

11. The MN of claim 9, wherein the CPC configuration information comprises information on whether the first target SN or the second target SN supports the selective SCG function.

12. The MN of claim 8, wherein the controller is further configured to receive, from the first target SN or the second target SN, a rejection message for a key value received by the first target SN or the second target SN or a request message for an additional key value.

13. The MN of claim 8, wherein the controller is further configured to transmit, to the UE, information on whether the first target SN not supporting the selective SCG function can be reused.

14. The MN of claim 13, wherein the controller is further configured to:
in case that the first target SN can be reused, receive a request for reuse of the first target SN from the UE;
select a third SN counter value for the first target SN and generating a third key value, based on the third SN counter value;
transmit the third key value to the first target SN; and
transmit, to the UE, the third SN counter value corresponding to the third key value.

15. A user equipment (UE) operating in a wireless communication system, the UE comprising:
a communication unit; and
a controller,
wherein the controller is configured to:
receive, from a master node (MN) connected to the UE, conditional PSCell change (CPC) configuration information, a first SN counter value corresponding to a first key value transferred to a first target secondary node (SN) not supporting a selective secondary cell group (SCG) function, and a plurality of second SN counters corresponding to a plurality of second key values transmitted to a second target SN supporting the selective SCG function,
generate a first key value or a second key value based on at least one of the first SN counter value or the plurality of second SN counter values, and
perform an SN change to the first target SN through the first key value or an SN change to the second target SN through the second key value.
